(19) United States
(12) Patent Application Publication
(10) Pub. No.: US 2026/0244684 A1
(43) Pub. Date: Aug. 20, 2026

(54) SYSTEMS AND METHODS FOR DE-POLLUTING SEARCH RESULTS

(71) Applicant: Adeia Guides Inc., San Jose, CA (US)

(72) Inventors: Jean-Yves Couleaud, Mission Viejo, CA (US); Charles Dasher, Lawrenceville, GA (US)

(21) Appl. No.: 19/053,636

(22) Filed: Feb. 14, 2025

(51) Int. Cl. G06F 16/583; G06F 16/51; G06F 16/538; G06F 16/55

(52) U.S. Cl. CPC G06F 16/583; G06F 16/51; G06F 16/538; G06F 16/55

(57) ABSTRACT

Systems and methods are described herein for enabling a search engine to group similar content into clusters. The disclosed methods maintain a database of indexed media content associated with a keyword, and compute representative values for feature embeddings that are extracted based on features (e.g., visual features) in the indexed content included in a cluster of indexed content. When new content associated with the keyword becomes available to the search engine, the feature embeddings of the new content are computed and compared to representative values for feature embeddings of the cluster, to determine if the new content should be placed into the existing cluster of content, or if a new cluster should be generated for the new content. The search engine may receive a search query comprising the keyword, and present content associated with each cluster. Thus, artificially generated search results may be distinguished from genuine search results.

### BACKGROUND

The present disclosure relates to classifying media content, such as images, and determining distinct content clusters based, for instance or at least in part, on encoder-generated embeddings that represent or characterize the content.

### SUMMARY

The growing use of AI-powered systems has resulted in great amounts of artificial or AI-generated content, and consequently search results that includes such AI-generated content, which causes great concern for systems that rely on visual accuracy and authenticity. Illustratively, image-based search results often lack context, realism or the precise visual information needed for vision-based computer systems. This issue is exacerbated by the inclusion of artificially generated images that are inadvertently indexed along with real-world (authentic or genuine) images, thus creating confusion or false equivalency. For example, e-commerce platform consumers may encounter product images that are seemingly convincing, but do not actually represent a real product, resulting in misleading expectations and eroding trust between brands and customers. This issue further results in poor performance for vision-based systems, such as for a self-driving vehicle that relies upon accurate identification of traffic lights, other vehicles, humans, animals, other objects or obstacles, and the like, to make autonomous or driver-assisted decisions in the real-world environment.

Additionally, the inclusion of artificially generated images in search results hinders scholarly and informational searches. For example, the ubiquity of AI-generated visuals in search results can overwhelm real data, making it even more difficult for systems to distinguish between reliable and accurate content. Furthermore, misinformation can easily spread when AI-generated images with incorrect visual details become conflated with legitimate data. For example, if AI systems generate historical or scientific visuals that inaccurately depict an event or phenomenon, these visuals can perpetuate inaccuracies. As AI models become more sophisticated, the lack of effective filters or tools to separate AI-generated images from authentic ones will lead to long-term challenges in content verification and the overall trustworthiness of data on the Internet.

In some approaches, systems that use algorithmic processes to rank images in search engines can struggle to differentiate between AI-generated content and genuine visuals. In some approaches, systems are configured to identify and embed the source of media content within a visual media item, such as a digital image, to ensure that images created by artificial means are distinguished from images obtained by actual captures (e.g., photography). However, these approaches do not solve the existing dissemination of synthetic images, nor prevent a search engine from referencing AI-generated images without origin information.

Some other approaches include filtering services that are focused on distinguishing AI-generated content, but these are focused on detecting AI images regardless of their representativity for the search query. Additional approaches attempt to apply time-based or keyword-based filters to remove AI images from search results, but these approaches may also eliminate non-AI images, and may also eliminate images created by artificial means that conform to the common norm of expected image results.

Therefore, there exists a need to accurately classify content associated with a search engine and determine distinct clusters of embeddings associated with the features of each content item returned for a particular search term over time. Additionally, the example systems and methods provided herein provide a system for explaining the reasons why a particular content item was excluded from presentation, providing transparency related to the particular procedures used to classifying the content. Furthermore, the example systems and methods provided herein relate to providing suggestions for a user to refine a search request to prevent the future dissemination of AI-generated content.

To help address problems of the above approaches, systems and methods are disclosed herein for analyzing the feature embeddings of media content, such as images, to classify the images and for generating distinct clusters based on common embeddings. In some embodiments, the feature embeddings are determined based on visual features associated with various portions of respective images. For example, a system may maintain a database for a plurality of indexed images received from a plurality of different media sources. In some embodiments, each indexed image is associated with a keyword used in a search query and a cluster of indexed images in the database. For example, all online images resulting from a search for “baby peacock” that include the same visual features will be represented by the same cluster of images.

In some embodiments, the system computes a set of representative values based on the set of feature embeddings for each image in the cluster by inputting each image into an image encoder. In some embodiments, the set of representative values are a set of average values. In some embodiments, the image encoder operates in a fixed embeddings space and is trained using large datasets of image-text pairs. In some embodiments, the set of average values are computed based on the output of the trained image encoder.

In some embodiments, the system identifies the availability of new images (e.g., new images that have recently been added to the web). In some embodiments, the system computes an additional set of average values based on the set of feature embeddings for the new images. In some embodiments, the system compares the set of average values for the indexed images with the set of average values for the new images to, for example, determine if the new images are sufficiently similar to the previously indexed images. In some embodiments, the system generates or determines a new cluster for the new images and updates the database to associate the new images with the new cluster and the keyword. In some embodiments, the system receives a search query comprising the keyword. Based on the search, the system generates a results set of images that are identified using the database. In some embodiments, the images are organized in a manner based on which cluster they are associated with. For example, images associated with a cluster may be presented in a portion of a user interface that is separate from a portion where images associated with the new cluster are presented.

Thus, the systems and methods disclosed herein provide for a database (e.g., search engine platform) of images that is capable of accurately distinguishing artificially generated content from content that is determined to be genuine. The systems and methods disclosed herein provide for organizing images into distinct clusters or groups, without eliminating images in the database. Additionally, the systems and methods disclosed herein may be applied to the plethora of genuine and artificial images that currently populate online platforms, as well as to the new images that may be provided to a platform in the future.

In some embodiments, the system includes an image encoder that is trained by accessing a dataset of image-text pairs. In some embodiments, each image-text pair in the dataset includes an image and an associated textual description related to the image. For example, an image-text pair may be one or more visual features in the images and the text that describes the visual features. In some embodiments, for each respective image-text pair in the dataset, the image encoder transforms a respective image of the respective image-text pair into a first respective vector representation. In some embodiments, a text encoder is used to transform respective text of the respective image-text pair into a second respective vector representation. In some embodiments, the image encoder is adjusted based on comparing the first respective vector representation and the second respective vector representation.

In some embodiments, the system generates the new cluster for the database based on determining that the images of the new cluster were artificially generated. In some embodiments, the system makes this determination by analyzing metadata respectively associated with the images of the new cluster. In some embodiments, generating the new cluster also includes marking or generating for display an identification of the new cluster as a cluster that contains artificially generated images.

In some embodiments, the system is configured to generate the results set of images on a portion of a user interface. In some embodiments, the system identifies a first portion of a user interface and a second portion of a user interface. In some embodiments, the indexed images associated with an existing cluster are presented in the first portion of the user interface, while the new images associated with a new cluster are presented in a second portion of the user interface. For example, images of baby peacocks that are determined to be genuine (e.g., a part of cluster of images with a high degree of accuracy) may be presented separately or distinguished from new images that contain artificially generated content.

In some embodiments, the system compares the set of average values for the indexed images with the set of average values for the new images by computing a difference vector between an average embeddings vector associated with the cluster of indexed images and an average embeddings vector for the plurality of new images. In some embodiments, the difference vector is compared to a standard deviation vector associated with the cluster of indexed images. In some embodiments, the standard deviation vector is associated with a deviation threshold. In some embodiments, based on the comparing, the system determines whether to generate the new cluster for the new images in the database.

In some embodiments, a particular cluster containing artificially generated images is disassociated from the search request comprising the keyword. For example, the system may receive a user-interface input requesting exclusion of artificially generated images from a results set. In some embodiments, the system also updates a search embeddings model to account for the disassociation of the cluster containing the artificially generated images. In some embodiments, in response to a search query including the keyword, the system generates for display only the images from the cluster of previously indexed images and excludes displaying the artificially generated images associated with the particular cluster.

In some embodiments, the system may generate an alert, in real time, when a search engine becomes populated with too many artificially generated images. For example, the system may determine a number of new images (e.g., or total images in a database) that are artificially generated and compare that number to a predetermined threshold number. In some embodiments, based on determining that the number of new images that are artificially generated exceeds the predetermined threshold, the system transmits an alert to a content source or administrator of a content source. In some embodiments, the alert indicates that high incidences of artificially generated images have occurred.

In some embodiments, the alert comprises a visual indicator associated with the new images that were artificially generated, information related to the database for the plurality of indexed images, an indication of what percentage of the plurality of indexed images in the database were artificially generated, a confidence score associated with at least one cluster that includes at least one new image that was artificially generated or a description of a classification of the at least one new image that was artificially generated in the at least one cluster.

In some embodiments, based on determining that some image search results contain artificially generated images, the system may generate for display a user interface suggestion to refine or improve search queries. For example, the system may generate for display one or more recommended search terms, one or more recommended search filters or a user-selectable option to view a subset of the results set of images in a separate portion of the user interface. For example, the system may recommend a term to append to the search “baby peacocks” in order to return more accurate or realistic images of baby peacocks.

In some embodiments, the system generates an explanation describing why a particular new image was artificially generated or associated with a particular cluster. For example, the system may generate a visualization describing the comparison between the set of respective feature embeddings for a genuine image and the set of respective feature embeddings for the at least one new image that was artificially generated, a textual description of the comparison, an indication of which specific feature embeddings of the set of respective feature embeddings exceeded a threshold deviation associated with one or more particular clusters, a respective confidence score associated with the one or more particular clusters, factors considered during computation of the respective confidence score, and/or a user-selectable option to interact with the explanation via the user interface.

In some embodiments, an image is associated with a timestamp at the moment it is indexed by the search engine. In some embodiments, the timestamp associated with feature embeddings is used to track the evolution of image features over time, as users continue to make search queries comprising the keyword. In some embodiments, the search engine stores the timestamp along with other data it stores for a particular image.

### BRIEF DESCRIPTION OF THE DRAWINGS

The present disclosure, in accordance with one or more various embodiments, is described in detail with reference to the following figures. The drawings are provided for purposes of illustration only and merely depict non-limiting examples and embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

The embodiments herein may be better understood by referring to the following description in conjunction with the accompanying drawings, in which like reference numerals indicate identical or functionally similar elements, of which:

FIG. 1A depicts an illustrative system for enabling a search engine to determine and compare feature embeddings respectively associated with groups of images, in accordance with some embodiments of the disclosure;

FIG. 1B depicts an illustrative system for enabling a search engine to generate clusters based on the feature embeddings associated with groups of images and to display the images based on the clusters, in accordance with some embodiments of the disclosure;

FIG. 2A depicts an illustrative graph representing the average feature embeddings for genuine images, in accordance with some embodiments of the disclosure;

FIG. 2B depicts an illustrative graph representing the average feature embeddings for synthetic images, in accordance with some embodiments of the disclosure;

FIG. 2C depicts an illustrative graph representing the difference between the average feature embeddings for genuine images and the average feature embeddings for synthetic images, in accordance with some embodiments of the disclosure;

FIG. 3 is a sequence diagram illustrating the process of calculating confidence scores for images and ranking images based on the respective confidence score, in accordance with some embodiments of the disclosure;

FIG. 4 is a sequence diagram illustrating the process of alerting a user based on detecting a sudden influx of visually different images, in accordance with some embodiments of the disclosure;

FIG. 5 is a sequence diagram illustrating the process of suggesting alternative search queries for a search engine based on the detecting of significant clusters of images for a particular search query, in accordance with some embodiments of the disclosure;

FIG. 6A is a sequence illustrating the process of displaying an explanation representing the justification for a content clustering result, in accordance with some embodiments of the disclosure;

FIG. 6B depicts an example embodiment for detecting a difference in the feature embeddings of images and determining whether a new cluster of images should be generated, in accordance with some embodiments of the disclosure;

FIG. 7A depicts a user interface display of search results from a search engine prior to identifying visually distinct clusters, in accordance with some embodiments of the disclosure;

FIG. 7B depicts an illustrative user interface display of labeling image results based on particular clusters, in accordance with some embodiments of the disclosure;

FIG. 7C depicts an illustrative user interface display of excluded search results based on particular clusters of content, in accordance with some embodiments of the disclosure;

FIG. 8 depicts illustrative devices and systems for enabling a search engine to determine and feature embeddings of images and cluster images based on the respective feature embeddings, in accordance with some embodiments of the disclosure;

FIG. 9 depicts devices and systems including a server, a communication network, and computing devices for performing the methods and processes noted herein, in accordance with some embodiments of the disclosure;

FIG. 10 is a flowchart of the process for determining feature embeddings for images and clustering images based on the respective feature embeddings, in accordance with some embodiments of the disclosure;

FIG. 11 is a flowchart of the process for determining that image search results contain artificially generated images and performing an action in response, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments and that the scope of the present invention is defined solely by the claims.

### DETAILED DESCRIPTION

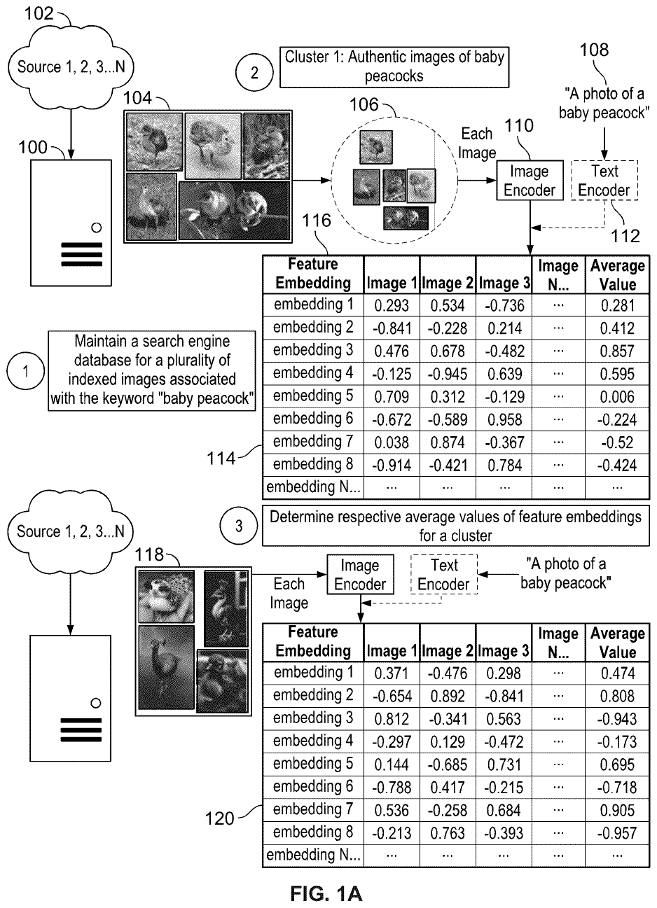

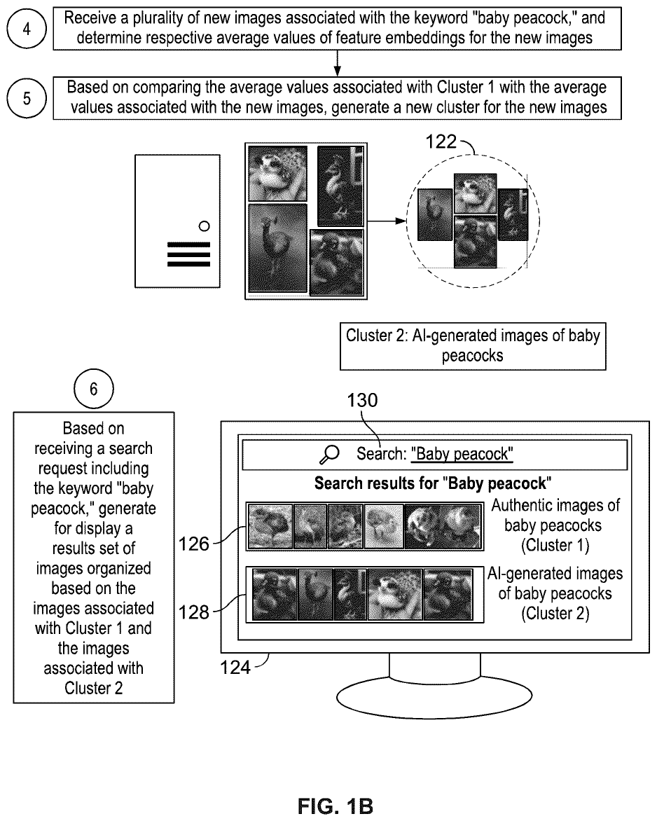

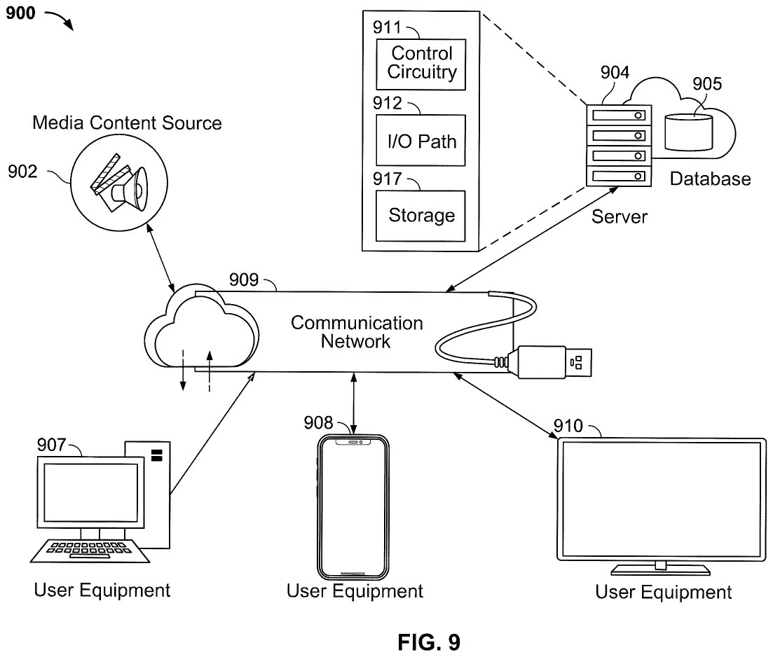

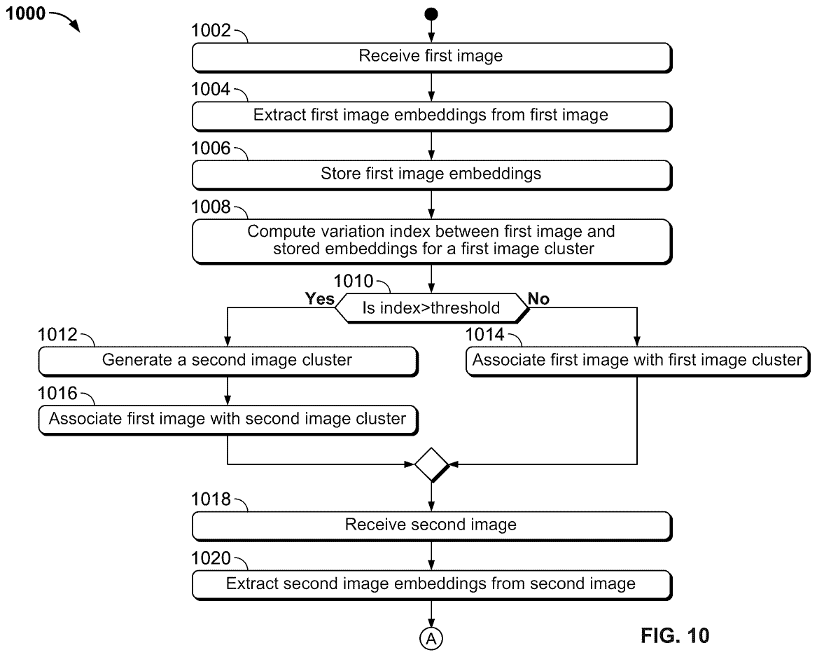

FIG. 1A depicts an illustrative system for enabling a search engine to determine and compare feature embeddings respectively associated with groups of content, in accordance with some embodiments of the disclosure. The various examples and embodiments described herein are applied to image content, but it should be appreciated that these techniques may be applicable to other forms of content, such as video, audio and text-based content, or any combination of digital media content. The techniques described herein may be implemented, at least in part, using servers associated with search engines or databases of media content, such as database 100 of FIG. 1A The various techniques described herein may be executed by control circuitry (e.g., 911, as further described in relation to FIG. 9) and/or by one or more remote servers (e.g., server 904 of FIG. 9 and/or media content source 902 of FIG. 9), and may utilize storage devices (e.g., database 905 of FIG. 9), at or distributed across any of one or more other suitable computing devices, in communication over any suitable number and/or types of networks (e.g., the internet). In some embodiments, applications, servers and/or devices comprise or employ any suitable number of displays, sensors or other devices, such as those further described in relation to FIGS. 8 and 9, or any other suitable software and/or hardware components, or any combination thereof. In some embodiments, the devices of the user, at which applications may be executed at least in part, comprise user equipment 907, 908 and 910 of FIG. 9. In some embodiments, the control circuitry is configured to execute the functions of the applications based on instructions stored in non-transitory memory (e.g., non-transitory memory or storage 808 of FIG. 9, and storage 917 of server 904 in FIG. 9).

In some approaches, digital media content is accessed from a variety of sources using network communications (e.g., the internet) and is not limited to images and video content. A variety of content sources (e.g., content sources 102) are associated with search engines (e.g., Google™, Yahoo™, Bing™, etc.), which provide an interface for a user to make a query and receive results containing the requested digital media content. The search engine maintains a database (e.g., database 100), which indexes digital media content, such as images (e.g., images 104). In some embodiments, the search engine obtains the digital media content by “crawling” the internet using automated bots. In some embodiments, the search engine obtains digital media content by using any suitable method for obtaining digital content from the internet.

As used herein, the term “search engine” should be broadly construed as any software running on one or more servers that is capable of performing any function related to searching for digital media content (e.g., including pre-processing, post-processing and indexing). For example, pre-processing may include the steps of analyzing data before it is indexed, in order to prepare the raw data to be efficiently retrieved. Indexing refers to the process of organizing the pre-processed data into a structured format to enable fast and accurate retrieval. For example, a search engine may create an index that maps search queries to relevant content. After a search engine retrieves results, post-processing encompasses the steps of refining the search results to improve relevance and accuracy for one or more users.

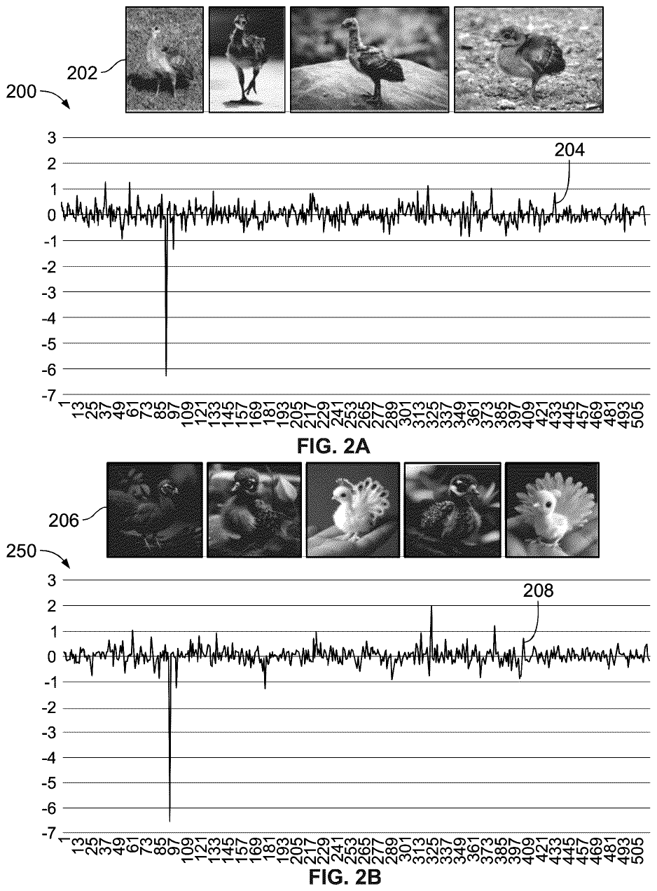

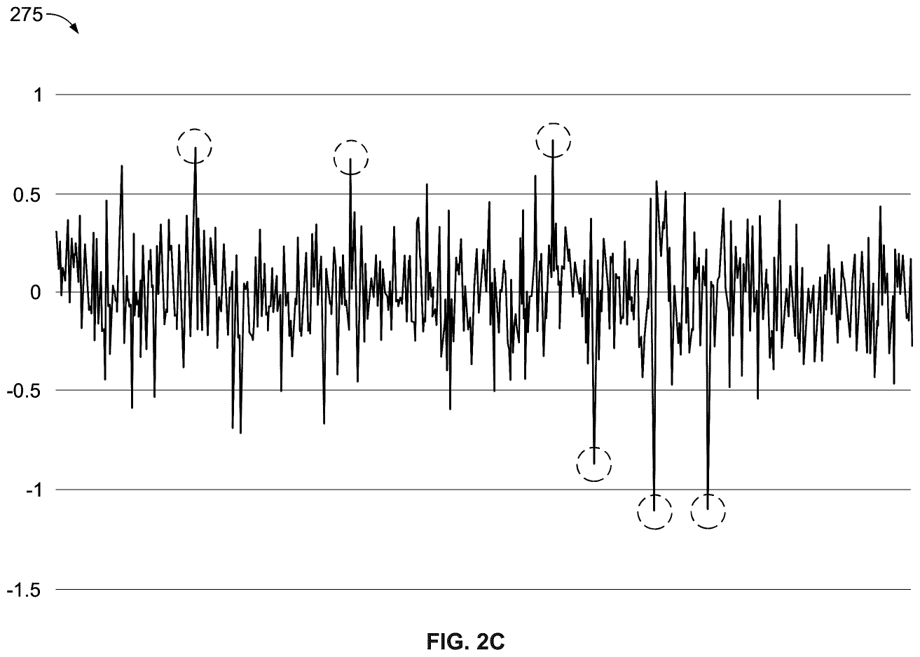

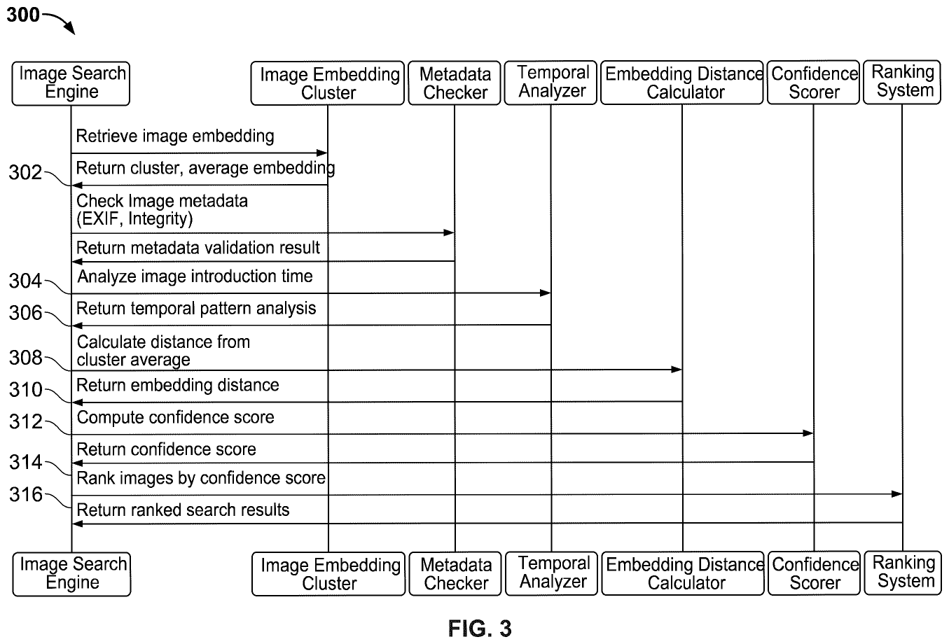

In some embodiments, the search engine utilizes an image encoder (e.g., image encoder 110) to record various visual features of each image obtained from content sources 102 (e.g., any suitable media source). For example, the search engine uses the image encoder to extract a respective representation of each visual feature identified in each image. In some embodiments, the search engine stores the recorded visual features of an image, as it is indexed, in the form of a set of embeddings, which are further described in relation to FIGS. 2A-2C. In some embodiments, the search engine stores a timestamp for each indexed image, such as the date and time the embeddings were generated, which coincides with the first time the search engine indexed the image. In some embodiments, for each image of images 104 that the search engine has indexed, the search engine generates timestamps, feature embeddings and search embeddings. In some approaches, search embeddings and feature embeddings may be the same, while in some approaches, they may be different. In some embodiments, the search embeddings are a representation of the metadata or other surrounding elements associated with an indexed image. In some embodiments, the search embeddings are feature embeddings in the case of a search engine using a vector-based image search. In some embodiments, the feature embeddings used to track the evolution of image features over time may be of a lower dimension than the feature embeddings used to index and return images for a search query. In some embodiments, both kinds of feature embeddings may be of the same dimension but result from different models. More detailed processes related to the generation of feature and search embeddings are described in relation to FIGS. 2A-2C.

In some embodiments, the search engine determines a set of feature embeddings (e.g., set of feature embeddings 116) for each image of images 104 that the search engine has indexed. In some embodiments, set of feature embeddings 116 is determined based on receiving metadata or one or more keywords associated with a search query. In some embodiments, the search engine receives a search query comprising one or more keywords, such as keyword 108. For example, the search engine may receive a user-input to launch a search query for “a photo of a baby peacock” (e.g., one or more keywords) by interacting with the browser interface of the search engine. In some embodiments, the search query is parsed for metadata or one or more keywords included in the query. For example, the search engine will index and determine a set of feature embeddings for each image returned as a result for the query “a photo of a baby peacock.” In some embodiments, search query 108 is input into a text encoder (e.g., text encoder 112) and the output is associated with the set of feature embeddings for an indexed image. For example, by monitoring the embeddings of each image it indexes for a specific search query, a search engine may detect significant changes in the makeup of these images.

In some embodiments, a search query comprises keyword 108 that is associated with metadata of images. For example, in the search query “a photo of a baby peacock,” keywords may be “photo” and “baby peacock.” In some embodiments, the keyword is represented in a vector space, such that variations of the keyword trigger search queries with similar parameters. For example, images associated with the keyword “baby peacock” may also be represented variations of the keyword, such as “peacock chicks” or “tiny peacocks,” which would also return comparable image results (e.g., images with similar feature embeddings). In some embodiments, the keyword and any associated image data are stored in database 100.

In some embodiments, once the search engine determines a respective set of feature embeddings for each image of images 104 that the search engine has indexed, the search engine may determine a representative value for each feature embedding across all of the indexed images that fall within the same search query. In some embodiments, the search engine generates embeddings maps for images it has indexed for a particular search query and computes a variation indicator or a proximity indicator, such as a standard deviation or a multi-dimensional distance to an average of these embeddings. In some embodiments the search engine detects the availability of a new image and indexes it by classifying the new image for the same search query. In some embodiments, the search engine computes a new standard deviation or set of standard deviations for the new image, as well as the average of the embeddings components of the previously indexed images. In some embodiments, the search engine stores this information, along with the rest of the data it stores for that new image, allowing it to evaluate the evolution of that measurement over time. In some embodiments, the information is stored in a data table, such as data table 114, which is included in database 100. While FIG. 1A depicts a search engine calculating an average for the feature embeddings respectively associated with the plurality of indexed images, it should be appreciated that a search engine may use any suitable mathematical formula (e.g., mode, median, etc.) for determining a relationship between sets of feature embeddings respectively associated with different images.

In some embodiments, the search engine compares a set of feature embeddings for a particular indexed image to the average feature embeddings based on the analysis of all images indexed for a particular search query. For example, the feature embeddings for an image may be associated with a score or value and compared to the representative value for the feature embeddings of all related images. In some embodiments, the representative value is an average value. In some embodiments, based on how closely feature embeddings of a particular indexed image match the average feature embeddings (e.g., standard deviation or a multi-dimensional distance), the search engine determines whether two or more images are visually similar. In some embodiments, the search engine may determine a visual similarity based on a threshold multi-dimensional distance or threshold standard deviation from an average.

In some embodiments, the search engine generates distinct groups or clusters of visually similar images. For example, the search engine may determine that images 104 are likely to represent sufficiently similar images of baby peacocks and generate cluster 106 comprising images 104. In some embodiments, the values associated with sets of feature embeddings respectively associated with each indexed image in cluster 106 are stored in data table 114 and maintained by the search engine. In some embodiments, the search engine determines the average values for the feature embeddings for a cluster of images. In some embodiments, the search engine compares the feature embeddings of new images to the average feature embeddings for the cluster to determine whether to add the new images to the existing cluster or whether to generate a new cluster to be associated with the new images. In some embodiments, data associated with cluster 106 is stored in database 100. For example, database 100 may indicate which images maintained by the search engine are associated with cluster 106.

In some embodiments, the search engine identifies the availability of a plurality of new images. For example, the search engine may monitor content sources 102 (e.g., online databases, websites, content providers, e-commerce platforms or any other suitable source of digital media content) to detect the availability of new images. In some embodiments, the search engine retrieves a plurality of new images 118 based on a search request for “a photo of a baby peacock.” In some embodiments, the search engine indexes each new image of new images 118 by inputting each new image into the image encoder (e.g., image encoder 110). In some embodiments, the search engine incorporates the output of the text encoder (e.g., text encoder 112) in order to associate a set of feature embeddings with the particular search query, for example, in the same vector space. In some embodiments, the search engine determines the feature embeddings for each new image of new images 118 based on the output of the image encoder and the output of the text encoder. In some embodiments, the feature embeddings are determined only from the output of the image encoder.

FIG. 1B continues the example embodiments depicted throughout FIG. 1A. FIG. 1B depicts an illustrative system for enabling a search engine generate clusters based on the feature embeddings associated with groups of images and to display the images based on the clusters, in accordance with some embodiments of the disclosure. In some embodiments, the search engine determines respective sets of feature embeddings 120 of FIG. 1A for each new image of new images 118 based on a particular search request. In some embodiments, the search engine determines the average values based on the respective sets of feature embeddings 120 for each new image. In some embodiments, the search engine compares the average values for the feature embeddings of the new images with the average feature embeddings for cluster 106 to determine a deviation between average respective feature embeddings. In some embodiments, the degree of the deviation is compared to a deviation threshold. In some embodiments, if the deviation between the average values for the feature embeddings of the new images and the average feature embeddings for cluster 106 does not meet or exceed the threshold deviation amount, the search engine adds new images 118 to cluster 106. In some embodiments, if the deviation between the average values for the feature embeddings of the new images and the average feature embeddings for cluster 106 meets or exceeds the threshold amount, the search engine generates a new cluster to be associated with new images 118. For example, based on comparing the average values associated with cluster 106 with the average values associated with the new images, the search engine generates new cluster 122 and associates the new images with new cluster 122. In some embodiments, the new cluster is generated automatically in response to a deviation meeting or exceeding the threshold deviation amount. Thus, the search engine attempts to isolate image results that are visually different from an accepted norm in related images. In some embodiments, database 100 is updated to include a reference to new cluster 122 associated with new images 118. In some embodiments, the search engine adds only a subset of new images 118 to cluster 106 or generates a new cluster for only a subset of new images 118.

In some embodiments, the search engine uses a clustering method, such a K-means, to verify that the new images fall within the same cluster as the previously indexed images. In some embodiments, such an approach is more compute-intensive because it requires a search engine to recompute a cluster arrangement for each new entry of an image. In some embodiments, a search engine reuses computations performed for previously indexed images in order to perform similar computations for the newly received images. In some embodiments, the search engine uses any suitable method of clustering digital media content based on similarities of features associated with the content.

In some embodiments, the search engine performs further analysis on new cluster 122 to determine that cluster 122 contains images that are visually distinct. For example, the search engine may utilize one or more image analysis techniques to determine that one or more visually distinct images in a cluster were artificially generated based on visual features or feature embeddings associated with respective portions of the one or more images. In some embodiments, the metadata associated with an image indicates that the image was artificially generated. For example, an image may be associated with a tag, watermark or some other suitable indication that, when analyzed by the search engine, indicates that the image is synthetic or artificially generated. As a further example, the metadata associated with an image may contain the name of the engine that generated the image. As yet another example, the metadata associated with an image may be missing aspects of metadata that are typically indicative of genuine media content, such as location metadata that indicates a geographic location where an image was captured by an image capturing device. In some embodiments, if a threshold number of images in a particular cluster are determined to be artificially generated, database 100 is updated to include an identifier indicating that the particular cluster contains artificially generated images. For example, a website administrator or owner may be capable of predefining a threshold percentage of images in a cluster being artificially generated, before the entire cluster is considered to be filled with artificially generated images. As a further example, an administrator may define the threshold at 20%, meaning that if 20% or more of the images in a cluster are verified to have been artificially generated, the cluster as a whole is considered to contain only artificially generated images and may be entirely excluded as image search results.

In some embodiments, multiple clusters of images are generated for the same first search query and the search engine ranks the resulting images based on their belonging to one cluster or another. In some embodiments, the search engine determines that a cluster of images it returns for one search query, is also present in another cluster for a second search query. In such a case, the search engine can use that information to present the results images in a certain order or group for the user entering the first query. Using the previous example, the first cluster represents images of real or genuine “baby peacocks” and may intersect with another cluster representing images of “farm animals,” while the second cluster represents images of synthetic “baby peacocks” and may intersect with another cluster representing images of “AI generated images.” Based on such information, the search engine may determine to present the first cluster of images first or present the second cluster of images in a separate browsing tab, for example. In some embodiments, even if the images are only referenced for one search query, the search engine presents image results based on the images belonging to one or another cluster.

While the present figure is primarily directed to clustering artificially generated and genuine content, respectively, based on a difference in feature embeddings, it should be appreciated that images may be clustered in any suitable manner based on a comparison of feature embeddings associated with a particular image or particular cluster. For example, Tesla's Cybertruck exhibits a distinctive shape when compared with typical trucks, and accordingly, the Cybertruck may be associated with a different cluster from the cluster associated with the keyword “pickup truck.”

In some embodiments, the search engine is enabled to disassociate a cluster of images from a particular keyword or set of keywords. For example, the search engine may decide to eliminate the batch of new images from the images it determines to return for “real baby peacocks” included in the search query. For example, based on comparing feature embeddings of new images 118 to the average feature embeddings of cluster 106, the search engine may determine to disassociate new images 118 from the search results of a similar query. In some embodiments, the user desires the artificially generated images of baby peacocks for, for example, use on a birthday card. The search engine may enable the user to disassociate the clusters containing images of “genuine” baby peacocks from a search for “fake baby peacocks” and thus return only the artificially generated images of baby peacocks as search results.

In some embodiments, the search engine determines it should disassociate a group of images based on how the group of images compare to a standard deviation, multi-dimensional distance or deviation threshold. In some embodiments, the search engine adjusts its search embeddings model to account for the fact that such images have been eliminated or disassociated from results of a particular query. For example, database 100 may be updated to indicate that new images 118 or cluster 122 is no longer associated with the search query comprising the term “baby peacock.” In some embodiments, disassociating or eliminating groups of images from search results for a particular query ensures that new images similar to the eliminated images will not be returned for search queries corresponding to original images. This concept is particularly important when a search engine operates in a hybrid mode, where both the essence of an image computed with machine learning (ML) models and the textual metadata associated with the image are used to index an image.

In some embodiments, the search engine receives a user-interface input comprising the keyword after the new images have been indexed. For example, the search engine may receive a user-interface input with a user device associated with the search engine (e.g., user device 124) to make search request 130. In some embodiments, search request 130 comprises the keyword or a variation of the keyword. In some embodiments, based on receiving search request 130 comprising the keyword, the search engine accesses database 100 to retrieve any stored clusters containing images associated with the keyword of search request 130. In some embodiments, the search engine returns multiple results sets of images (e.g., results sets 126 and 128) and displays the images associated with the results sets of images via a display of user device 124. In some embodiments, the results sets of images are determined based on one or more clusters of images. For example, the images displayed in results set 126 may be associated only with cluster 106, while the images displayed in results set 128 may be associated only with cluster 122 that was generated for the new images. As a further example, if the search engine receives a search request containing the keyword “baby peacock,” the search engine will retrieve all the clusters associated with the keyword, such as clusters 106 and 122. Because cluster 106 is determined to be associated with genuine images of baby peacocks and cluster 122 is determined to contain artificially generated images of baby peacocks, the search engine will arrange the display of resulting images by positioning the images of genuine baby peacocks in results set 126 in a separate portion of the display from the artificially generated images of baby peacocks displayed in results set 128.

FIG. 2A depicts an illustrative graph representing the average feature embeddings for genuine images, in accordance with some embodiments of the disclosure. In some embodiments, the techniques described in FIGS. 2A-2C are applied to representing distinct features in any other form of digital media content, or any combination thereof. For example, the search engine is configured to use tools that recognize a wide variety of visual concepts in media content and associate them with their names. As a result, these tools can then be applied to nearly arbitrary visual classification tasks. In some embodiments, the search engine uses one or more tools (e.g., CLIP) to pre-train the image encoder and the text encoder to predict which images were paired with which texts in a dataset. In some embodiments, the search engine uses the one or more tools to extract visual embeddings from one or more images, such as images 202. For example, the search engine may be capable of accessing a dataset of image-text pairs, which may be stored in a database (e.g., database 100 of FIG. 1A). In some embodiments, each image-text pair comprises an image and associated text that describes one or more portions of the image. In some embodiments, for each image-text pair, the search engine transforms an image of a respective image-text pair into a first vector representation in a fixed embeddings space using the image encoder (e.g., image encoder 110 of FIG. 1A). In some embodiments, for each image-text pair, the search engine additionally transforms text of a respective image-text pair into a second vector representation in the same fixed embeddings space using a text encoder (e.g., text encoder 112 of FIG. 1A). In some embodiments, both the image encoder and the text encoder target the same vector space.

In some embodiments, the search engine compares the first vector representation for the image of an image-text pair to the second vector representation for the text of the image-text pair to generate the score or value for the one or more respective feature embeddings associated with an image. For example, each feature embedding may be represented by one vector component in the feature vector space, and several feature embeddings may be represented by several vector components, respectively.

As a further example, a search engine may plot the various scores associated with feature embeddings for an image by generating graph 200. In some embodiments, graph 200 illustrates the representative values of one or more vector components 204, which are respectively associated with various feature embeddings. In some embodiments, the x-axis of graph 200 represents the dimension index of feature embeddings (e.g., vector components indexes) and the y-axis represents the particular value of an embedding at a particular index. In some embodiments, the curve of graph 200 represents the average representative values for feature embeddings for multiple images. In some embodiments, spikes in the curve of graph 200 indicate a significant relationship between a particular feature and an image. In some embodiments, graph 200 represents the average feature embeddings for a group or cluster of images, such as cluster 106 of FIG. 1A. In some embodiments, graph 200 represents the average feature embeddings for visually distinct images of baby peacocks, based on a related search.

While the data contributing to graph 200 relates to visual features of images, it should be appreciated that only the image encoder may understand the true relationship between a visual feature and the corresponding feature embedding value depicted in the graph. Thus, for example, while a spike in the graph may indicate a significant relationship between a particular feature and an image, a human viewing the graph would not be able to understand what the significance of the relationship means unless the indexes in the graph are explainable. In some embodiments, classification models may implement named classes that are labeled and readily understandable. Additionally, while the feature embeddings of the graph 200 were extracted using CLIP, it should be appreciated that any suitable image feature-extraction technique, associated with text, may be used instead of CLIP or in combination with CLIP.

FIG. 2B depicts an illustrative graph representing the average feature embeddings for synthetic images, in accordance with some embodiments of the disclosure. In some embodiments, the search engine extracts feature embeddings from images in any manner as described in relation to FIGS. 1A-1B and 2A. For example, the search engine may receive a plurality of new images 206 (which may be the same as new images 118 of FIG. 1A) and extract the feature embeddings 208 using the image encoder. In some embodiments, the search engine generates graph 250 to plot the values associated with the average feature embeddings respectively associated with the images from new images 206. In some embodiments, the x-axis of graph 250 represents the dimension index of feature embeddings (e.g., vector components) and the y-axis represents the particular value of an embedding at a particular index. In some embodiments, graph 250 represents the average feature embeddings for synthetic or artificially generated images of baby peacocks, based on a related search.

FIG. 2C depicts an illustrative graph representing the difference between the average feature embeddings for genuine images and the average feature embeddings for synthetic images, in accordance with some embodiments of the disclosure. For example, the search engine may compare at least a subset of the values of the features embeddings represented by graph 200 with the subset of the values represented by graph 250 in order to generate graph 275, which describes the difference between the average values for the feature embeddings respectively associated with each set of images 202 and 206.

In some embodiments, once the values associated with feature embeddings of respective image sets are analyzed, the search engine is enabled to compute the variation indicator or a proximity indicator described in relation to FIGS. 1A-1B, which may be a standard deviation or a multi-dimensional distance to an average of these embeddings. Thus, new images may be compared to the multi-dimensional distance to the average embeddings of the previous images to determine the extent of their visual similarity.

In some embodiments, the search engine detects a significant uptick in standard deviation, which triggers the automatic clustering of images per embeddings vector. In some embodiments, the search engine begins to create separate rankings for new images that are determined to belong to new clusters. For example, using the example provided by FIGS. 2A-2C, the search engine may detect a change in the average embeddings vectors for the set of genuine images after just a few images from the set of new, artificially generated images are indexed. In such a scenario, the search engine may generate a first cluster for the set of genuine images and a second cluster for the first few pictures from the set of new, artificially generated images. Continuing the above example, upon receiving additional images from the set of new, artificially generated images, the search engine may analyze the feature embeddings of the additional images and determine that those also belong in the second cluster of images.

In some embodiments, the variation indicator (e.g., the variation indicator described in relation to FIG. 1A) is the average of the standard deviation of the components of the image's feature embeddings. In some embodiments, each image associated with a set of images (bp1, bp2, bp3, bp4) (e.g., the previously described set of genuine images) is associated with an embeddings vector:

$$bp 1 = [ ebp {1}_{1} , ebp {1}_{2} , … ebp {1}_{N} ]$$

$$bp 2 = [ ebp {2}_{1} , ebp {2}_{2} , … ebp {2}_{N} ]$$

$$bp 3 = [ ebp {3}_{1} , ebp {3}_{2} , … ebp {3}_{N} ]$$

$$bp 4 = [ ebp {4}_{1} , ebp {4}_{2} , … ebp {4}_{N} ]$$

In some embodiments, a standard deviation vector can be computed with σebpₖ=STDDEV[ebp1ₖ ebp2ₖ, ebp3ₖ, ebp4ₖ]. In some embodiments, the average embeddings vector can also be computed with mebpₖ=AVG (ebp1ₖ ebp2ₖ, ebp3ₖ, ebp4ₖ). In some embodiments, when a new image from a set of new images is indexed, the search engine computes a difference vector between the average embeddings vector for previously indexed images and the new image embeddings vector. The search engine then compares the difference vector to the computed standard deviation vector in order to detect a change in the makeup of the new image embeddings vectors and the already indexed embeddings vectors.

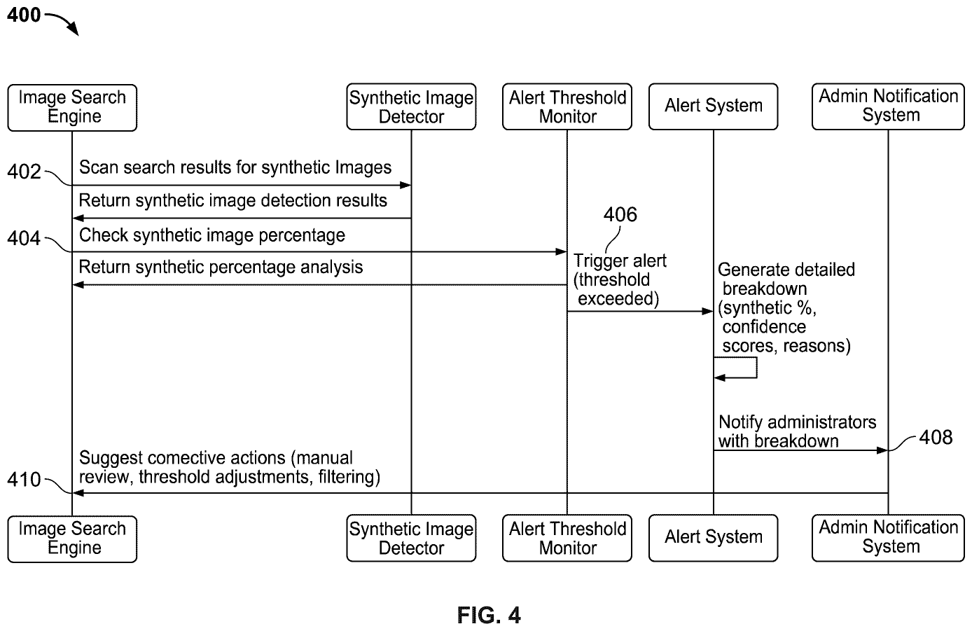

FIG. 3 is a sequence diagram illustrating the process of calculating confidence scores for images and ranking images based on the respective confidence score, in accordance with some embodiments of the disclosure. For example, process 300 begins at step 302 where a search engine receives the average feature embeddings for a cluster of images (e.g., cluster 106 of FIG. 1A). In some embodiments, at step 304, new images are received by the search engine, and an image introduction time is analyzed by a temporal analyzer. In some embodiments, at step 306, a temporal pattern analysis is received by the search engine from the temporal analyzer. For example, the temporal pattern analysis may indicate why the new images may have appeared as search results for various queries over a period of time.

In some embodiments, at step 308, the search engine compares the value of feature embeddings for the new images to the average feature embeddings for the cluster of images in order to calculate a multi-dimensional distance to an average of the embeddings for the cluster. In some embodiments, at step 310, the multi-dimensional distance is determined by an embedding distance calculator, which transmits the embedding distance of the new images to the search engine. In some embodiments, at step 312, the search engine computes a confidence score using a confidence scorer.

In some embodiments, the search engine assigns a confidence score to each cluster of images indexed by the search engine. In some embodiments, the confidence score reflects the search engine's certainty about whether the images within the cluster are reliably grouped together and characterized, for instance, as sufficiently distinct from other images in other clusters. For example, the search engine may determine that the images within a particular cluster were artificially generated. In some embodiments, the confidence score is calculated based on the above factors, such as the multi-dimensional distance of the new image's embedding from the established cluster's average embeddings, metadata integrity (e.g., presence or absence of EXIF data), and the temporal pattern of the image's introduction (e.g., why the new images appeared in previous search results). In some embodiments, new images that deviate significantly from the established cluster, either in embedding structure or metadata properties, are assigned a lower confidence score, indicating a higher likelihood that they should be a part of a different cluster of images. In some embodiments, at step 314, the search engine ranks images based on the respectively assigned confidence scores. For example, at step 316, the search engine may organize the search results in a manner based on its ranking, prioritizing images with a high confidence of belonging to a particular cluster, while either down-ranking or segregating images with a low confidence of belonging to a particular cluster.

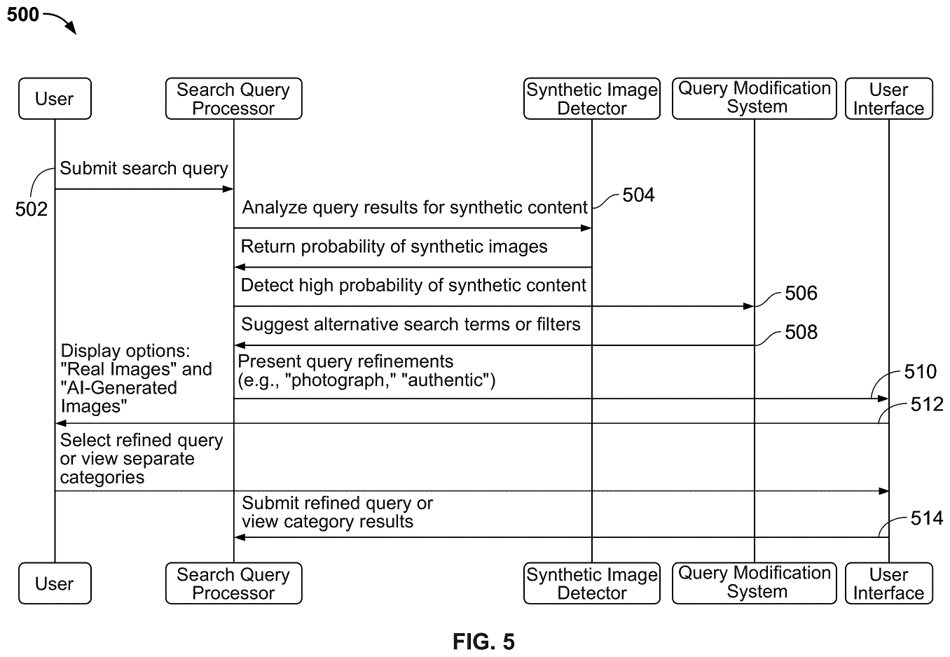

FIG. 4 is a sequence diagram illustrating the process of alerting a user based on detecting a sudden influx of visually different images, in accordance with some embodiments of the disclosure. For example, process 400 begins at step 402, where a search engine scans search results to a search query to detect synthetic or artificially generated images. In some embodiments, the search engine performs step 402 by using a synthetic image detector. In some embodiments, process 400 proceeds to step 404, where the search engine submits the images to an alert threshold monitor to determine a percentage of the search results that contains synthetic images. For example, in response to a search query comprising the keywords “baby peacock,” a search engine may access search results from cluster 106 of FIG. 1A (e.g., genuine images of baby peacocks) and search results from cluster 122 of FIG. 1B (e.g., artificially generated images of baby peacocks), as both clusters are associated with the same plurality of keywords.

In some embodiments, the search engine is capable of issuing real time alerts when a particular search query becomes polluted with synthetic images. For example, the search engine may receive a synthetic image percentage analysis from the alert threshold monitor that indicates how many images of the search results are synthetic or artificially generated. In some embodiments, the search engine compares the amount or percentage of synthetic images to a predetermined threshold amount or percentage to detect a significant influx of content (AI-generated or not).

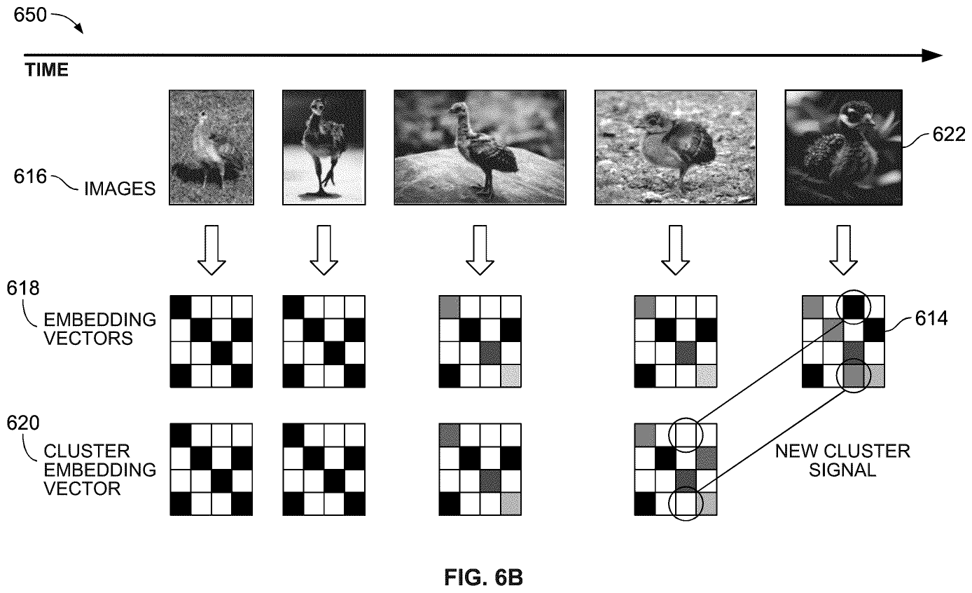

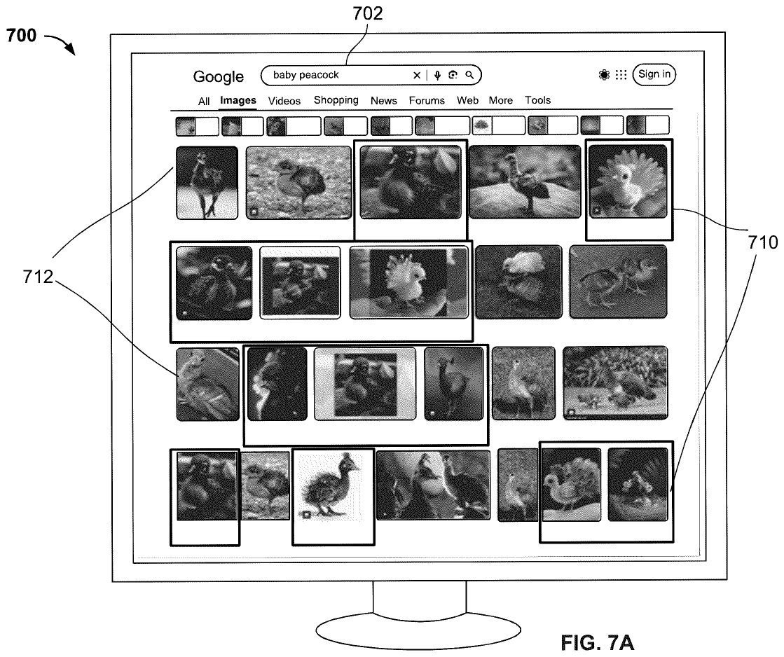

In some embodiments, at step 406, the search engine triggers a notification or alert to an alert system of the search engine administrators or website owners based on the amount or percentage of images meeting or exceeding the predetermined threshold. In some embodiments, the notification or alert provides a detailed breakdown of the polluted dataset, including the percentage of synthetic images detected, the confidence scores of various clusters, and the potential reasons for classification. In some embodiments, the detailed breakdown is generated using explainable AI (XAI), which is further described in relation to FIGS. 6A-6B.

In some embodiments, at step 408, the search engine administrators or website owners receive the notification or alert from the alert system. In some embodiments, at step 410, based on the alert, administrators can take corrective actions, such as manually reviewing flagged images, adjusting thresholds for clustering, or implementing temporary filters to prioritize authentic content.

In some embodiments, the search engine dynamically adjusts the threshold for clustering images based on the context of the search query. For example, the search engine may utilize different threshold values for detecting variations in embedding distances, depending on various factors, such as the search category (e.g., scientific vs. entertainment) or the temporal nature of the images (e.g., newly emerging trends vs. well-established topics). In some embodiments a baseline threshold is preset by a website administrator or search engine provider. As a further example, in a scientific query, the system may apply stricter thresholds, allowing minimal deviation between images to avoid the inclusion of synthetic content. Conversely, for trending topics with rapidly evolving visual content, the search engine is enabled to apply more lenient thresholds to allow for greater variance within the image cluster.

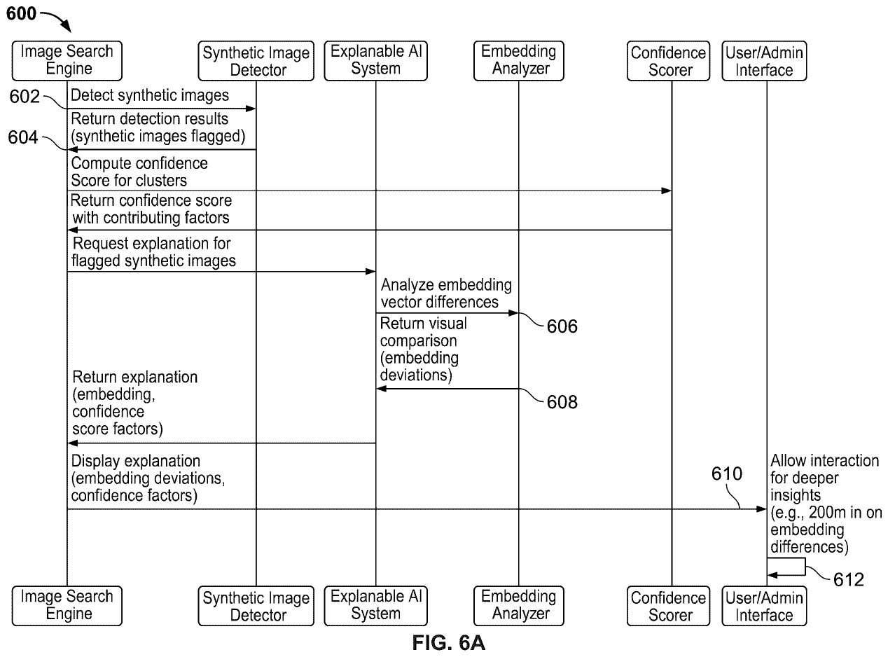

FIG. 5 is a sequence diagram illustrating the process of suggesting alternative search queries for a search engine based on the detecting of significant clusters of images for a particular search query, in accordance with some embodiments of the disclosure. For example, process 500 begins at step 502, where a user submits a search query to search for media content. In some embodiments, the user submits the search query by making a user-interface input on a device associated with the search engine.

In some embodiments, at step 504, the search engine performs a search and analyzes the results for a particular search query using a synthetic image detector. In some embodiments, the synthetic image detector determines what percentage of image search results were synthetically or artificially generated. In some embodiments, at step 506, the search engine determines that there is a high probability of synthetic content polluting the image search results. In some embodiments, at step 508, in response to detecting a high probability of synthetic images for a given query, the search engine offers the user alternative search terms to use in a new query or different searching filters, such as “photograph,” “authentic,” or “real,” to narrow the results to more reliable images. In some embodiments, pre-emptive query-modification refinements prevent the inclusion of synthetic content in the search results.

In some embodiments, at step 510, the search engine presents the suggested query refinements via the user interface of a user device. In some embodiments, at step 512, based on the suggested query refinements, the search engine can present the user with user-selectable options to view the image search results in separate tabs, such as browsing tabs labeled as “Real Images” or “AI-Generated Images,” allowing for easy navigation between the two categories of search results. In some embodiments, at step 514, the search engine provides a user-selectable option to submit a refined query or to select a category of images to view.

FIG. 6A is a sequence diagram illustrating the process of displaying an explanation representing the justification for a content clustering result, in accordance with some embodiments of the disclosure. For example, process 600 begins at step 602, where a search engine uses a synthetic image detector in order detect synthetic or artificially generated images in a set of image search results generated in response to a search query. In some embodiments, the search engine determines synthetic images in any manner as previously described in relation to FIGS. 1A-5. For example, in response to accessing search results from cluster 106 of FIG. 1A (e.g., genuine images of baby peacocks) and search results from cluster 122 of FIG. 1B (e.g., artificially generated images of baby peacocks), the search engine may use the synthetic image detector to determine that at least some of the images in the search results have been artificially generated.

In some embodiments, detection results are provided to the search engine and, at step 604, the search engine uses a confidence scorer to compute the confidence scores for a cluster of search results. In some embodiments, the confidence scorer provides the search engine with the confidence scores and the various factors that contributed to computation of the scores (e.g., the multi-dimensional distance of the new image's embedding from the established cluster's average embeddings, metadata integrity, and the temporal pattern of the image's introduction). In some embodiments, based on the confidence score associated with flagged synthetic images, the search engine requests an explanation for the flagged synthetic images. In some embodiments, at step 606, the explainable AI (XAI) mechanism is used to provide transparency and interpretability for users and administrators, and communicates with an embedding analyzer to analyze the embeddings vector difference between the synthetic images and previously indexed images.

In some embodiments, at step 608, the embedding analyzer generates a visual comparison or visual explanations (e.g., as shown by visual explanation 650 of FIG. 6B) of the embedding differences between the synthetic and real images maintained by the search engine. For example, when a synthetic image is flagged, the search engine can generate for display at a user device a comparison of the embeddings vectors and offer explanations for the calculation of the confidence score assigned to each cluster, detailing the various key factors (e.g., embedding distance, metadata anomalies, or provenance inconsistencies) contributing to the classification (e.g., at step 610). In some embodiments, at step 612, the various textual and visual explanations provide user-selectable options for users and administrators to interact with these explanations through the interface of the user device to obtain deeper insights into the search engine's decision-making processes.

FIG. 6B depicts an example embodiment for detecting a difference in the feature embeddings of images and whether a new cluster of images should be generated, in accordance with some embodiments of the disclosure. In some embodiments, illustration 650 depicts the process for detecting a difference in feature embeddings between images, in the same fixed embeddings space. In some embodiments, the process of illustration 650 is performed by the search engine and may be used alternatively or in combination with any of the graphs described in relation to FIGS. 2A-2C. For example, illustration 650 depicts a comparison of the embeddings vectors 618 and 620 for images 616, highlighting the specific dimensions where a significantly different image (e.g., a synthetic image) deviates from the established cluster. As a further example, images 616 are each respectively represented by embeddings vectors 618. Images 616 may have been previously grouped or clustered based on their similar embeddings values, and the average embeddings of the cluster as a whole are represented by cluster embeddings vectors 620.

In some embodiments, as time progresses and more images become available to the search engine, the embeddings 614 of new image 622 are compared with the embeddings of the cluster to determine whether to add new image 622 to the cluster. For example, images 616 may be the same as images 104 of FIG. 1A. In this example, new image 622 may be one of new images 118 of FIG. 1A, and its respective feature embeddings are being compared to the embeddings of cluster 106, to determine whether to add the new images to the existing cluster or generate a new cluster for the new images. In some embodiments, illustration 650 depicts a visual representation of the comparison between cluster embeddings vectors 620 and new image embeddings vectors 614 to highlight the exact dimensions of the vector space where new image 622 differs from the cluster. In some embodiments, illustration 650 depicts that a new cluster signal was triggered based on the comparison of feature embeddings vectors. For example, a computed difference between sets of feature embeddings may be compared to a threshold value to determine the extent or significance of the difference. If the computed difference meets or exceeds the threshold value, the new cluster signal may be triggered. In some embodiments, illustration 650 shows that the search engine associates a particular embeddings vector with a color and adjusts the shade or opacity of the color based on the representative value associated with the particular embedding. For example, the opacity of colors associated with a particular embeddings vector may correspond to the spikes in the graph of FIG. 2C, which show the difference feature embeddings. In some embodiments, illustration 650 shows that the search engine utilizes relevant numerical values or mathematical equations associated with the visual components of images to analyze further details.

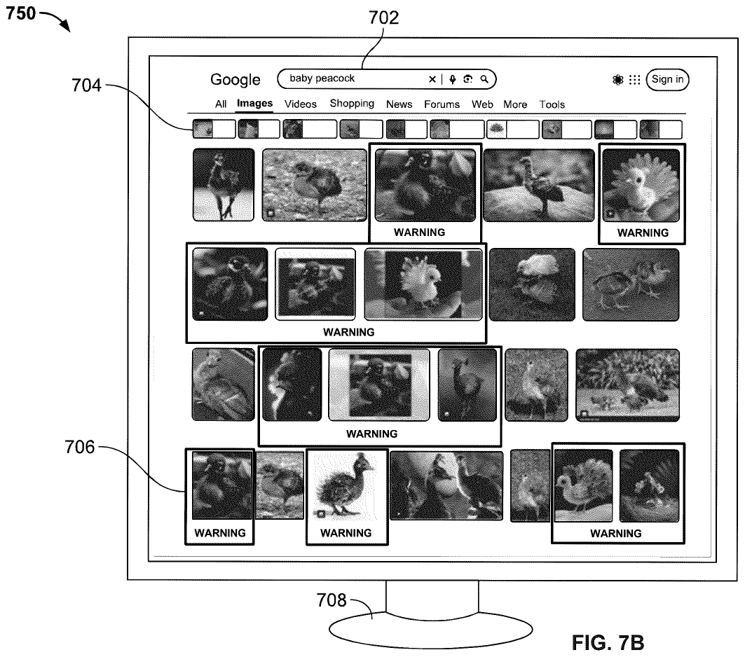

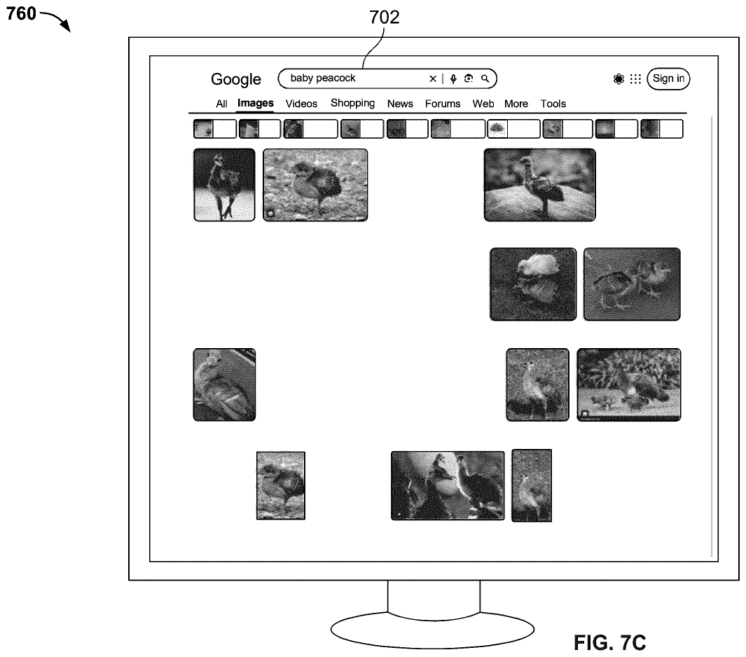

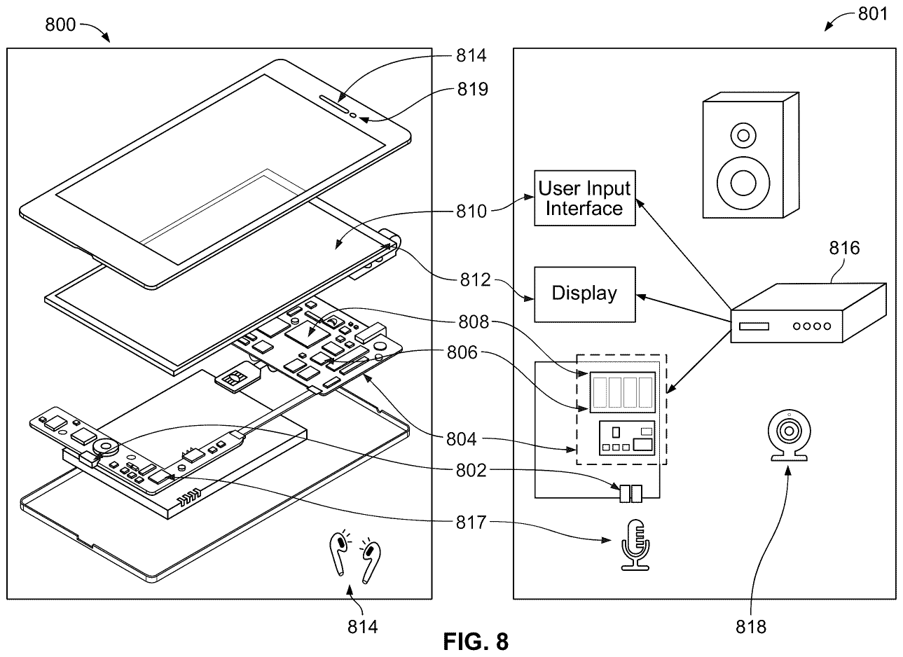

FIG. 7A depicts a user interface display of search results from a search engine prior to identifying visually distinct clusters (e.g., as described in relation to FIGS. 1A-1B and 10-11). For example, prior to identifying clusters of content, a search engine may receive search query 702 to identify images of “baby peacocks.” In response to receiving a search query for “baby peacocks,” the search engine provides user interface 700 that displays genuine images of baby peacocks 712 side-by-side artificially generated images of baby peacocks 710. As shown in FIG. 7A, search engines may fail to distinguish visually distinct images or modify a display of search results to highlight desired search results.

FIG. 7B depicts an illustrative user interface display of labeling image results based on particular clusters, in accordance with some embodiments of the disclosure. For example, user interface 750 may be displayed via any user device 708, which may be user device 124 of FIG. 1B. In some embodiments, a search engine receives search query 702 based on detecting a user-interface input. For example, search query 702 may contain a search request for images of baby peacocks. In some embodiments, the search engine analyzes the search results (e.g., in any manner as previously described) to determine whether some of the search results are visually distinct from other search results (e.g., genuine or artificially generated images). For example, the search engine may have previously generated a cluster of genuine images of baby peacocks, and proceeds to compare the feature embeddings of the search result images to the average feature embeddings of the cluster. In some embodiments, the search results contain metadata that indicates whether they are genuine or not.

In some embodiments, based on determining that at least some of the images returned as search results are visually distinct, the search engine may perform a number of user-interface modifications to highlight the visually distinct content. For example, the search engine may highlight, indicate or partially/wholly remove synthetic or artificially generated content from a listing of search results. In some embodiments, the search engine may generate a label, colored border, highlight or other visually distinguishing adjustment to associate with a particular synthetic search result. For example, label 706 may indicate visually distinct images by providing a text-based alert, such as “warning,” in large and/or colored letters for particular search results because they have been flagged as visually distinct. For example, a “warning” label may be used to provide a user with notice that certain search results have been artificially generated. In some embodiments, the search engine uses similar visually distinguishing techniques to emphasize other visually distinct content (e.g., the genuine or real search results), instead of the artificially generated results. For example, genuine search results may be modified to include a bright colored borders, indicating that they are safe to be relied upon for authenticity. In some embodiments, the search engine utilizes a combination of different visually distinguishing modifications to highlight search results.

In some embodiments, filters or suggested terms 704 are displayed via the user interface. In some embodiments, filters or suggested terms 704 are the same as the user suggestions, described in relation to FIG. 5, that are intended to assist a user in refining a search query to avoid certain content (e.g., synthetic or artificially generated results). In some embodiments, the suggestions comprise recommended search terms, one or more recommended search filters or one or more user-selectable options to view a subset of the results set of images in a separate portion of the user interface. In some embodiments, the user interface of FIG. 7 is configured to display any combination of the following: human-readable, text-based explanations; visual indicators associated with the new images that were artificially generated, indications of which percentage of the plurality of indexed images in the database were artificially generated; a confidence score associated with at least one cluster that includes at least one new image that was artificially generated; and descriptions of a classification of the at least one new image that was artificially generated in the at least one cluster. For example, the user-interface may provide the XAI explanations along with visualizations of the differences in the embeddings respectively associated with images and clusters of images. In some embodiments, user interface 750 provides a textual, visual or audio (or any suitable combination) explanation explaining how each image was determined to be included in the cluster and subsequently in the search results.

FIG. 7C depicts an illustrative user interface display of excluded search results based on particular clusters of content, in accordance with some embodiments of the disclosure. In some embodiments, user interface 760 is configured to display search results based on their respective associations with a specific cluster and/or based on whether the search result is authentic. For example, user interface 760 may be displayed via any user device 708, which may be user device 124 of FIG. 1B. In some embodiments, user interface 760 is the same as user interface 750 of FIG. 7B. In some embodiments, the search a user desires to view only the visually distinct search results. For example, as depicted in FIG. 7C, a search engine may receive a user-interface input to exclude any artificially generated content (e.g., a content filter), and the search engine will display only genuine images via the user interface. In some embodiments, the search engine receives a user-interface input to present all search results, but to present the visually distinct (e.g., genuine or real) search results in a portion of the user interface that is separate from the other (e.g., synthetic or artificially generated) search results (e.g., as shown in relation to FIGS. 1A-1B). For example, in response to such an input, the search engine may arrange authentic search results in a first row or column in a top portion of the user interface, while presenting the artificially generated search results in a second row or column in a bottom portion of the user interface. In some embodiments, the user interface displays user-selectable options to modify the display of search results, such as to present artificially generated content in one or more first browsing tabs and to present authentic content in one or more other browsing tabs. In some embodiments, the techniques described in relation to FIGS. 7B-7C are used to generate the display of search results described in relation to user device 124 of FIG. 1B.

FIG. 8 depicts illustrative devices and systems for enabling a search engine to determine and feature embeddings of images and cluster images based on the respective feature embeddings, in accordance with some embodiments of the disclosure.

FIG. 8 shows generalized embodiments of illustrative user equipment 800 and 801. For example, user equipment 800 may be a smartphone device, a laptop, a tablet, a near-eye display device, an XR device, or any other suitable device. In another example, user equipment 801 may be a user television equipment system or device. User equipment 801 may include set-top box 816. Set-top box 816 may be communicatively connected to microphone 817, audio output equipment (e.g., speaker or headphones 814), and display 812. In some embodiments, microphone 817 may receive audio corresponding to a voice of a video conference participant and/or ambient audio data during a video conference. In some embodiments, display 812 may be a television display or a computer display. In some embodiments, set-top box 816 may be communicatively connected to user input interface 810. In some embodiments, user input interface 810 may be a remote-control device. In some embodiments, user input interface 810 also comprises I/O circuitry. Set-top box 816 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 9. In some embodiments, device 800 may comprise any suitable number of sensors (e.g., gyroscope or gyrometer, or accelerometer, etc.), and/or a GPS module (e.g., in communication with one or more servers and/or cell towers and/or satellites) to ascertain a location of device 800. In some embodiments, device 800 comprises a rechargeable battery that is configured to provide power to the components of the device.

Each one of user equipment 800 and user equipment 801 may receive content and data via input/output (I/O) path 802. I/O path 802 may provide content (e.g., broadcast programming, on-demand programming, internet content, content available over a local area network (LAN) or wide area network (WAN), and/or other content) and data to control circuitry 804, which may comprise processing circuitry and storage 808. Control circuitry 804 may be used to send and receive commands, requests, and other suitable data using I/O path 802, which may comprise I/O circuitry. I/O path 802 may connect control circuitry 804 (and specifically the processing circuitry) to one or more communications paths (described below). I/O functions may be provided by one or more of these communications paths, but are shown as a single path in FIG. 8 to avoid overcomplicating the drawing. While set-top box 816 is shown in FIG. 8 for illustration, any suitable computing device having processing circuitry, control circuitry, and storage may be used in accordance with the present disclosure. For example, set-top box 816 may be replaced by, or complemented by, a personal computer (e.g., a notebook, a laptop, a desktop), a smartphone (e.g., device 800), an XR device, a tablet, a network-based server hosting a user-accessible client device, a non-user-owned device, any other suitable device, or any combination thereof.

Control circuitry 804 may be based on any suitable control circuitry such as processing circuitry. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 804 executes instructions for the media application stored in memory (e.g., storage 808). Specifically, control circuitry 804 may be instructed by the media application to perform the functions discussed above and below. In some implementations, processing or actions performed by control circuitry 804 may be based on instructions received from the media application.

In client/server-based embodiments, control circuitry 804 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 8, the instructions may be stored in storage 808, and executed by control circuitry 804 of a device 800.

In some embodiments, the media application may be a client/server application where only the client application resides on device 800, and a server application resides on an external server (e.g., server 904 and/or media content source 902). For example, the media application may be implemented partially as a client application on control circuitry 804 of device 800 and partially on server 904 as a server application running on control circuitry 911. Server 904 may be a part of a local area network with one or more of devices 800, 801 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 904 and/or an edge computing device), referred to as “the cloud.” Device 800 may be a cloud client that relies on the cloud computing capabilities from server 904 to generate personalized engagement options in a VR environment. The client application may instruct control circuitry 804 to generate personalized engagement options in a VR environment.

Control circuitry 804 may include communications circuitry suitable for communicating with a server, edge computing systems and devices, a table or database server, or other networks or servers. The instructions for carrying out the above-mentioned functionality may be stored on a server (which is described in more detail in connection with FIG. 9). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 9). In addition, communications circuitry may include circuitry that enables peer-to-peer communication of user equipment, or communication of user equipment in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as media application data described above. Nonvolatile memory may also be used (e.g., to launch a boot-up routine and other instructions). Cloud-based storage, described in relation to FIG. 8, may be used to supplement storage 808 or instead of storage 808.

Control circuitry 804 may receive instruction from a user by way of user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of user equipment 800 and user equipment 801. For example, display 812 may be a touchscreen or touch-sensitive display. In such circumstances, user input interface 810 may be integrated with or combined with display 812. In some embodiments, user input interface 810 includes a remote-control device having one or more microphones, buttons, keypads, any other components configured to receive user input or combinations thereof. For example, user input interface 810 may include a handheld remote-control device having an alphanumeric keypad and option buttons. In a further example, user input interface 810 may include a handheld remote-control device having a microphone and control circuitry configured to receive and identify voice commands and transmit information to set-top box 816.

Audio output equipment 814 may be integrated with or combined with display 812. Display 812 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 812. Audio output equipment 814 may be provided as integrated with other elements of each one of device 800 and device 801 or may be stand-alone units. An audio component of videos and other content displayed on display 812 may be played through speakers (or headphones) of audio output equipment 814. In some embodiments, audio may be distributed to a receiver (not shown), which processes and outputs the audio via speakers of audio output equipment 814. In some embodiments, for example, control circuitry 804 is configured to provide audio cues to a user, or other audio feedback to a user, using speakers of audio output equipment 814. There may be a separate microphone 817 or audio output equipment 814 may include a microphone configured to receive audio input such as voice commands or speech. For example, a user may speak letters or words that are received by the microphone and converted to text by control circuitry 804. In a further example, a user may voice commands that are received by a microphone and recognized by control circuitry 804. Camera 818 may be any suitable video camera integrated with the equipment or externally connected. Camera 818 may be a digital camera comprising a charge-coupled device (CCD) and/or a complementary metal-oxide semiconductor (CMOS) image sensor. Camera 818 may be an analog camera that converts to digital images via a video card.

The media application may be implemented using any suitable architecture. For example, it may be a stand-alone application wholly implemented on each one of user equipment 800 and user equipment 801. In such an approach, instructions of the application may be stored locally (e.g., in storage 808), and data for use by the application is downloaded on a periodic basis (e.g., from an out-of-band feed, from an internet resource, or using another suitable approach). Control circuitry 804 may retrieve instructions of the application from storage 808 and process the instructions to provide video conferencing functionality and generate any of the displays discussed herein. Based on the processed instructions, control circuitry 804 may determine what action to perform when input is received from user input interface 810. For example, movement of a cursor on a display up/down may be indicated by the processed instructions when user input interface 810 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 804 may allow a user to provide user profile information or may automatically compile user profile information. For example, control circuitry 804 may access and monitor network data, video data, audio data, processing data, participation data from a conference participant profile. Control circuitry 804 may obtain all or part of other user profiles that are related to a particular user (e.g., via social media networks), and/or obtain information about the user from other sources that control circuitry 804 may access. As a result, a user can be provided with a unified experience across the user's different devices.

In some embodiments, the media application is a client/server-based application. Data for use by a thick or thin client implemented on each one of user equipment 800 and user equipment 801 may be retrieved on-demand by issuing requests to a server remote to each one of user equipment 800 and user equipment 801. For example, the remote server may store the instructions for the application in a storage device. The remote server may process the stored instructions using circuitry (e.g., control circuitry 804) and generate the displays discussed above and below. The client device may receive the displays generated by the remote server and may display the content of the displays locally on device 800. This way, the processing of the instructions is performed remotely by the server while the resulting displays (e.g., that may include text, a keyboard, or other visuals) are provided locally on device 800. Device 800 may receive inputs from the user via input interface 810 and transmit those inputs to the remote server for processing and generating the corresponding displays. For example, device 800 may transmit a communication to the remote server indicating that an up/down button was selected via input interface 810. The remote server may process instructions in accordance with that input and generate a display of the application corresponding to the input (e.g., a display that moves a cursor up/down). The generated display is then transmitted to device 800 for presentation to the user.

In some embodiments, the media application may be downloaded and interpreted or otherwise run by an interpreter or virtual machine (run by control circuitry 804). In some embodiments, the media application may be encoded in the ETV Binary Interchange Format (EBIF), received by control circuitry 804 as part of a suitable feed, and interpreted by a user agent running on control circuitry 804. For example, the media application may be an EBIF application. In some embodiments, the media application may be defined by a series of JAVA-based files that are received and run by a local virtual machine or other suitable middleware executed by control circuitry 804. In some of such embodiments (e.g., those employing MPEG-2, MPEG-4, HEVC or any other suitable digital media encoding schemes), the media application may be, for example, encoded and transmitted in an MPEG-2 object carousel with the MPEG audio and video packets of a program.

FIG. 9 depicts illustrative devices and systems including a server, a communication network, and computing devices for performing the methods and processes noted herein, in accordance with some embodiments of the disclosure.

As shown in FIG. 9, user equipment 907, 908 and 910 may be coupled to communication network 909. Communication network 909 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 909) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths, but are shown as a single path in FIG. 9 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 909.

System 900 may comprise media content source 902, one or more servers 904, database 905, and/or one or more edge computing devices. In some embodiments, the media application may be executed at one or more of control circuitry 911 of server 904 (and/or control circuitry of user equipment 907, 908, 910 and/or control circuitry of one or more edge computing devices). In some embodiments, the media content source and/or server 904 may be configured to host or otherwise facilitate video communication sessions between user equipment 907, 908, 910 and/or any other suitable user equipment, and/or host or otherwise be in communication (e.g., over network 909) with one or more social network services.

In some embodiments, server 1004 may include control circuitry 911 and storage 917 (e.g., RAM, ROM, Hard Disk, Removable Disk, etc.). Storage 917 may store one or more databases. Server 904 may also include an I/O path 912. I/O path 912 may provide video conferencing data, device information, or other data, over a local area network (LAN) or wide area network (WAN), and/or other content and data to control circuitry 911, which may include processing circuitry, and storage 917. Control circuitry 911 may be used to send and receive commands, requests, and other suitable data using I/O path 912, which may comprise I/O circuitry. I/O path 912 may connect control circuitry 911 (and specifically control circuitry) to one or more communications paths.

Control circuitry 911 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 911 executes instructions for an emulation system application stored in memory (e.g., the storage 917). Memory may be an electronic storage device provided as storage 917 that is part of control circuitry 911.

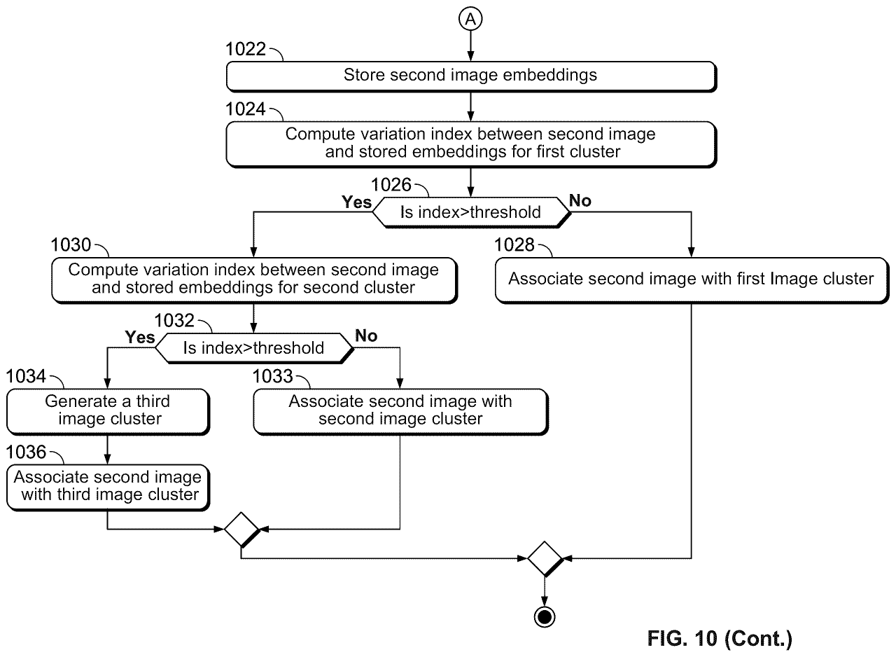

FIG. 10 is a flowchart of the process for determining feature embeddings for images and clustering images based on the respective feature embeddings, in accordance with some embodiments of the disclosure. In various embodiments, the individual steps of process 1000 may be implemented by one or more components of the devices, techniques, and software of FIGS. 1-9. Although the present disclosure may describe certain steps of process 1000 (and of other processes described herein) as being implemented by certain components of the devices and software of FIGS. 1-9, this is for purposes of illustration only, and it should be understood that other components of the devices and systems of FIGS. 1-9 may implement those steps instead.

Process 1000 begins at step 1002, where the control circuitry (e.g., control circuitry 804 or 911 of FIGS. 8 and 9, respectively) receives digital media content from a media content source (e.g., media content source 902 of FIG. 9 and/or content sources 102 of FIG. 1A). For example, the control circuitry may receive a first image to be processed. In some embodiments, the control circuitry receives a different form of digital media content, such as audio, video or text-based content. At step 1004, a search engine extracts feature embeddings associated with a first image. In some embodiments, the search engine extracts feature embeddings in any manner as described in relation to FIGS. 1A-7 (e.g., by using an image encoder). In some embodiments, at step 1006, the extract feature embeddings associated with the first image are stored in a database associated with the search engine (e.g., database 100 of FIG. 1A).

In some embodiments, at step 1008, the search engine compares the feature embeddings associated with the first image to the stored feature embeddings associated with a previously generated first cluster of images to compute a variation index. In some embodiments, the variation index is the variation indicator or a proximity indicator described in relation to FIGS. 1A-1B. In some embodiments, the variation index is the multidimensional distance, distance to average or standard deviation further described in relation to FIGS. 1A-7. At step 1010, the variation index is compared to a threshold variation value. In some embodiments, if the variation index is not greater than the threshold variation, process 1000 proceeds to step 1014, where the search engine determines that the first image is sufficiently similar to the images of the first cluster and associates the first image with the first cluster of images. In some embodiments, the search engine determines the variation index or some other deviation between sets of feature embeddings in any manner as described in relations to FIGS. 1A-7. In some embodiments, the variation threshold is preset by, for example, a website administrator, as described in relation to FIG. 4.

In some embodiments, if the variation index exceeds the threshold variation, and process 1000 proceeds to step 1012, where the search engine determines that the first image is different from the images included in the first cluster and should be associated with a different cluster. In some embodiments, at step 1012, the search engine generates a second image cluster, and at step 1016, associates the first image with the second cluster of images. In some embodiments, process 1000 ends when the search engine associates the first image with the first cluster of images at step 1014 or when the search engine associates the first image with the second generated cluster at step 1016.

In some embodiments, process 1000 proceeds to step 1018, where the search engine receives a second image from the content source(s). For example, the second image may be one of new images 118 of FIG. 1A, and the search engine determines whether to add one or more of the new images to the existing cluster or whether to generate a new cluster for the new images. In some embodiments, similar to step 1004, at step 1020, the search engine extracts the feature embeddings from the second image. At step 1022, the search engine stores the set of feature embeddings associated with the second image in the database. In some embodiments, at step 1024, similar to step 1004, the search engine compares the extracted feature embeddings associated with the second image to the stored feature embeddings associated with a previously generated first cluster of images to compute a variation index. In some embodiments, at step 1026, the variation index is compared to a threshold variation value. In some embodiments, in response to determining that the variation index does not exceed the threshold variation, process 1000 proceeds to step 1028, where the search engine associates the second image with the first cluster of images, and process 1000 ends.

In some embodiments, if the variation index is greater than the threshold variation, process 1000 proceeds to step 1030, where the search engine makes a second variation index computation between the extracted feature embeddings associated with the second image and the feature embeddings associated with the generated second cluster of images. In some embodiments, at step 1032, the second variation index is compared to the threshold variation value to determine if the set of feature embeddings associated with the second image is sufficiently similar to the feature embeddings associated with the second cluster. In some embodiments, the threshold variation value associated with the second cluster is different or is the same as the threshold variation value associated with the first cluster of images. In some embodiments, in response to determining that the second variation index does not exceed the threshold variation for the second cluster of images, process 1000 proceeds to step 1033, where the search engine associates the second image with the second cluster of images, and process 1000 ends.

In some embodiments, in response to determining that the second variation index is greater than the threshold variation for the second cluster of images, process 1000 proceeds to step 1034, where the search engine generates a third cluster of images. In some embodiments, at step 1036, the search engine associates the second image with the generated third cluster of images, and process 1000 ends. For example, based on comparing the feature embeddings of the second image with the average feature embeddings of each of the previously generated clusters of images, the search engine may determine that the second image is not sufficiently similar to any of the images in the existing clusters and a new cluster corresponding to the particular feature embeddings of the second image should be generated.

In some embodiments, as new images are received by the search engine, portions of process 1000 are repeated to determine whether the new images should be associated with an existing cluster of images (e.g., cluster 1, cluster 2 or cluster 3) or if a new cluster should be generated for the new images based on the feature embeddings corresponding to the new images. In some embodiments, as new images are added to existing clusters, the average feature embeddings of the existing cluster may be adjusted based on the inclusion of the new images in the cluster, and the database is updated to reflect the new makeup of feature embeddings over time.

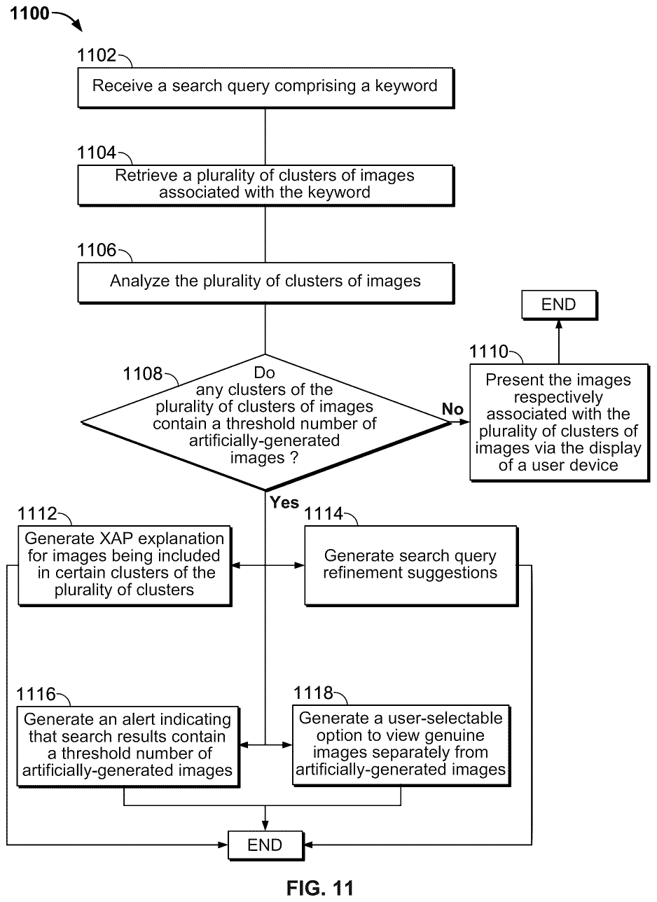

FIG. 11 is a flowchart of the process for determining that image search results contain artificially generated images and performing an action in response, in accordance with some embodiments of the disclosure. In various embodiments, the individual steps of process 1100 may be implemented by one or more components of the devices, techniques, and software of FIGS. 1-10. Although the present disclosure may describe certain steps of process 1100 (and of other processes described herein) as being implemented by certain components of the devices and software of FIGS. 1-10, this is for purposes of illustration only, and it should be understood that other components of the devices and systems of FIGS. 1-10 may implement those steps instead.

Process 1100 begins at step 1102, where the control circuitry (e.g., control circuitry 804 or 911 of FIGS. 8 and 9, respectively) receives a search query comprising a keyword. In some embodiments, the search query is a request for “photo of a baby peacock” as used in the examples in relation to FIGS. 1A-1B. In some embodiments, the keyword and associated images are stored in a database, such as database 100 of FIG. 1A. In some embodiments, at step 1104, in response to receiving a search query comprising the keyword, the search engine accesses the database to retrieve a plurality of clusters of images associated with the keyword. For example, images associated with the keyword may have been previously indexed by the search engine, and the search engine generates clusters of images with similar visual features. In some embodiments, the search engine clusters images in any manner as described in relation to FIGS. 1A-7 and 10.

In some embodiments, at step 1106, the control circuitry of a search engine analyzes the plurality of clusters of images to determine whether any of the clusters of the plurality of clusters contain artificially generated images. For example, images that are a part of a particular cluster may be associated with metadata that indicates whether the image was artificially generated or not. As a further example, based on comparing feature embeddings associated with images and clusters (e.g., as described in relation to FIGS. 1A-7), the control circuitry may determine that a cluster of images contains artificially generated images. In some embodiments, the control circuitry determines a number of artificially generated images that are included in the retrieved plurality of clusters of images.

In some embodiments, at step 1108, the control circuitry compares the number of artificially generated images in the plurality of clusters to a threshold number of artificially generated images. For example, a website or search engine administrator may predefine the number of artificially generated images to be allowed in a search results set before the search results set is considered to be too polluted with synthetic content. In some embodiments, if the number of artificially generated images in the retrieved plurality of clusters of images does not meet or exceed the threshold number for a particular search, process 1100 proceeds to step 1110, where the control circuitry presents the images associated with the plurality of clusters at a display of a user device (e.g., user device 124 of FIG. 1), and process 1100 ends.

In some embodiments, the number of artificially generated images in the retrieved plurality of clusters of images meets or exceeds the threshold number for a particular search, and process 1100 proceeds to steps 1112, 1114, 1116 or 1118, where the control circuitry and/or I/O circuitry performs an action in response to the comparison related to the number of artificially generated images.

In some embodiments, process 1100 proceeds to step 1112, where the control circuitry generates an XAI explanation of the clustering of certain images. In some embodiments, the XAI explanation is the same as or similar to the XAI explanation described in relation to FIGS. 6A-6B. For example, the I/O circuitry can generate for display a visual comparison of the embeddings vectors and offer explanations for the calculation of the confidence score assigned to each image and cluster, detailing the various key factors (e.g., embedding distance, metadata anomalies, or provenance inconsistencies) contributing to the classification of certain images. As a further example, the control circuitry may flag content determined to be synthetic, and the XAI explanation provides details related to the determination. In some embodiments, process 1100 ends after step 1112.

In some embodiments, process 1100 proceeds to step 1114, where the control circuitry generates search query refinement suggestions via the display of the user device, and process 1100 ends. For example, as further described in relation to FIG. 5, a search engine may generate alternative search terms or suggest certain searching filters for a user to reduce the number of artificially generated images that appear in search results.

In some embodiments, process 1100 proceeds to step 1116, where the control circuitry generates an alert or a notification to a website administer indicating that search results associated with a particular query or keyword are polluted with synthetic content, and process 1100 ends. For example, as described in relation to FIG. 4, the notification or alert provides a detailed breakdown of the polluted dataset, including the percentage of synthetic images detected; the confidence scores of various clusters; and the potential reasons for classification. In some embodiments, the notification or alert includes a user-selectable option to generate the XAI explanation related to step 1112, which contains the detailed breakdown.

In some embodiments, process 1100 proceeds to step 1118, where the I/O circuitry generates user-selectable options to control the display of search results, such that artificially generated image results are displayed separately, visually distinguished or excluded entirely from the display of genuine search results. For example, as described in relation to FIGS. 1A-1B and 7, the search engine may employ any combination of separating search results into different portions of a display, presenting synthetic content in a separate tab, highlighting the synthetic or artificially generated content and/or labelling artificially generated content in order to reduce the inclusion of artificially generated content in the search results. In some embodiments, process 1100 ends after step 1118.

While steps 1112, 1114, 1116 and 1118 are depicted in FIG. 11 as separate steps to avoid overcomplicating the drawing, it should be appreciated that, in some embodiments, any combination of steps 1112, 1114, 1116 and 1118 may be performed by the search engine in response to determining that clusters of images contains at least a threshold number of artificially generated images.

Additionally, while FIGS. 10-11 provide separate examples of various embodiments, it should be appreciated that one or more of the steps of these examples may be considered in combination.

Throughout the specification, the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
maintaining a database for a plurality of indexed images received from a plurality of sources, wherein a first indexed image of the plurality of indexed images is associated with at least one keyword and with a first cluster of indexed images for the at least one keyword;
computing, for the first cluster, a first set of one or more representative values for a set of one or more feature embeddings, wherein the one or more representative values is computed by analyzing a respective image of the plurality of indexed images;
identifying a plurality of second images associated with the at least one keyword;
computing, for the plurality of second images, a second set of one or more representative values for the set of one or more feature embeddings;
based at least in part on comparing the second set of one or more representative values with the first set of one or more representative values:
generating a second cluster for the database; and
updating the database such that each image of the plurality of second images is associated with the at least one keyword and the second cluster;
receiving a search request comprising the at least one keyword; and
generating for display a results set of images identified using the database, wherein the results set of images is organized based at least in part on the first cluster and the second cluster.

2. The method of claim 1, wherein the respective image is analyzed by an image encoder, and wherein the image encoder is trained by:
accessing a dataset of image-text pairs, wherein an image-text pair in the dataset comprises an image and an associated text description;
transforming a respective image of a respective image-text pair into a first respective vector representation in a fixed embeddings space using the image encoder;
transforming respective text of the respective image-text pair into a second respective vector representation in the fixed embeddings space using a text encoder; and
adjusting the image encoder based at least in part on comparing the first respective vector representation and the second respective vector representation.

3. The method of claim 2, wherein a respective image-text pair comprises at least one respective visual feature associated with a portion of the respective image and the respective text describing the at least one respective visual feature.

4. The method of claim 1, wherein the generating the second cluster for the database comprises:
determining that images of the second cluster are artificially generated by analyzing metadata respectively associated with a subset of the images of the second cluster,
wherein the generating for display the results set of images comprises generating for display an identification of the second cluster as a cluster of artificially generated images.

5. The method of claim 4, further comprising:
disassociating the second cluster from future search requests comprising the at least one keyword by adjusting a search embeddings model to account for the disassociation; and
based at least in part on receiving a new search request comprising the at least one keyword, generating for display a subset of the plurality of indexed images associated with the first cluster while excluding the subset of the images associated with the second cluster.

6. The method of claim 4, further comprising:
based at least in part on comparing a number of images of the second cluster that were artificially generated to a threshold number: transmitting an alert to at least one source of the plurality of sources, wherein the alert indicates high incidences of artificially generated images.

7. The method of claim 6, wherein transmitting the alert causes at least one of:
generating for display a visual indicator associated with the images of the second cluster that were artificially generated;
generating for display information related to the database for the plurality of indexed images;
generating for display an indication of a percentage of the plurality of indexed images in the database that were artificially generated;
generating for display a confidence score associated with at least one cluster that includes at least one image that was artificially generated; or
generating for display a description of a classification of the at least one image that was artificially generated in the at least one cluster.

8. The method of claim 4, further comprising:
generating for display, on a user interface, a suggestion for a user to refine the search request comprising the at least one keyword, wherein the suggestion comprises at least one of: one or more recommended search terms, one or more recommended search filters, or a user-selectable option to view a subset of the results set of images in a separate portion of the user interface.

9. The method of claim 4, further comprising:
generating for display, on a user interface, an explanation associated with at least one second image of the plurality of second images that was artificially generated, wherein the explanation comprises a visualization of a comparison between the set of one or more respective feature embeddings for a genuine image and the set of one or more respective feature embeddings for the at least one second image that was artificially generated.

10. The method of claim 9, wherein the explanation further comprises an indication of a specific feature embedding of the set of one or more feature embeddings that exceeded a threshold deviation associated with one or more particular clusters.

11. The method of claim 1, wherein the generating for display the results set of images comprises:
generating for display images of the first cluster in a first portion of a user interface; and
generating for display images of the second cluster in a second portion of the user interface.

12. The method of claim 1, wherein the first set of one or more representative values is a set of average one or more respective values for the set of one or more feature embeddings; and wherein the comparing the second set of one or more representative values with the first set of one or more representative values comprises:
computing a difference vector between an average embedding vector associated with the set of one or more feature embeddings for the first cluster and an average embedding vector associated with the set of one or more feature embeddings for the plurality of second images;
comparing the difference vector to a standard deviation vector associated with the first cluster; and
determining, based at least in part on the comparing, whether to generate the second cluster for the database.

13. A system comprising:
a memory;
an input/out circuitry; and
a control circuitry configured to:
maintain a database for a plurality of indexed images received from a plurality of sources, wherein a first indexed image of the plurality of indexed images is associated with at least one keyword and with a first cluster of indexed images for the at least one keyword, and wherein the database is stored in the memory;
compute, for the first cluster, a first set of one or more representative values for a set of one or more feature embeddings, wherein the one or more representative values is computed by analyzing a respective image of the plurality of indexed images;
identify a plurality of second images associated with the at least one keyword;
compute, for the plurality of second images, a second set of one or more representative values for the set of one or more feature embeddings;
wherein the I/O circuitry is configured to:
based at least in part on comparing the second set of one or more representative values with the first set of one or more representative values:
generate a second cluster for the database; and
update the database such that each image of the plurality of second images is associated with the at least one keyword and the second cluster;
receive a search request comprising the at least one keyword; and
generate for display a results set of images identified using the database, wherein the results set of images is organized based at least in part on the first cluster and the second cluster.

14. The system of claim 13, wherein the control circuitry is configured to analyze the respective image by using an image encoder, and wherein the control circuitry is further configured to train the image encoder by:
accessing a dataset of image-text pairs, wherein an image-text pair in the dataset comprises an image and an associated text description;
transforming a respective image of a respective image-text pair into a first respective vector representation in a fixed embeddings space using the image encoder;
transforming respective text of the respective image-text pair into a second respective vector representation in the fixed embeddings space using a text encoder; and
adjusting the image encoder based at least in part on comparing the first respective vector representation and the second respective vector representation.

15. The system of claim 14, wherein a respective image-text pair comprises at least one respective visual feature associated with a portion of the respective image and the respective text describing the at least one respective visual feature.

16. The system of claim 13, wherein the I/O circuitry is configured to generate the second cluster for the database by:
determining that images of the second cluster are artificially generated by analyzing metadata respectively associated with a subset of the images of the second cluster,
wherein the I/O circuitry is configured to generate for display the results set of images by generating for display an identification of the second cluster as a cluster of artificially generated images.

17. The system of claim 16, wherein the control circuitry is further configured to:
disassociate the second cluster from future search requests comprising the at least one keyword by adjusting a search embeddings model to account for the disassociation; and
wherein the I/O circuitry is further configured to:
based at least in part on receiving a new search request comprising the at least one keyword, generate for display a subset of the plurality of indexed images associated with the first cluster while excluding the subset of the images associated with the second cluster.

18. The system of claim 16, wherein the I/O circuitry is further configured to:
based at least in part on comparing a number of images of the second cluster that were artificially generated to a threshold number: transmit an alert to at least one source of the plurality of sources, wherein the alert indicates high incidences of artificially generated images.

19. The system of claim 18, wherein the I/O circuitry is configured to transmit the alert by causing at least one of:
generating for display a visual indicator associated with the images of the second cluster that were artificially generated;
generating for display information related to the database for the plurality of indexed images;
generating for display an indication of a percentage of the plurality of indexed images in the database that were artificially generated;
generating for display a confidence score associated with at least one cluster that includes at least one image that was artificially generated; or
generating for display a description of a classification of the at least one image that was artificially generated in the at least one cluster.

20. The system of claim 16, wherein the I/O circuitry is further configured to:
generate for display, on a user interface, a suggestion for a user to refine the search request comprising the at least one keyword, wherein the suggestion comprises at least one of: one or more recommended search terms, one or more recommended search filters, or a user-selectable option to view a subset of the results set of images in a separate portion of the user interface.

21-60. (canceled)
